(19) United States
(12) Patent Application Publication
(10) Pub. No.: US 2026/0106777 A1
(43) Pub. Date: Apr. 16, 2026

(54) CHANNEL ESTIMATION FOR FREQUENCY DIVISION DUPLEX COMMUNICATIONS

(71) Applicant: QUALCOMM Incorporated, San Diego, CA (US)

(72) Inventors: Vasanthan RAGHAVAN, West Windsor Township, NJ (US); Xiaoxia ZHANG, San Diego, CA (US); Junyi LI, Greentown, PA (US)

(21) Appl. No.: 18/911,739

(22) Filed: Oct. 10, 2024

(51) Int. Cl. H04L 25/02; H04L 5/00; H04L 5/14; H04W 24/10

(52) U.S. Cl. CPC H04L 25/0204; H04L 5/0051; H04L 5/14; H04W 24/10

(57) ABSTRACT

Certain aspects of the present disclosure provide techniques for channel estimation for frequency division duplexing (FDD) communications, An example method for wireless communications by a user equipment (UE) includes obtaining one or more reference signals (RSs); sending, for each cluster of a set of clusters, an indication of cluster information, wherein the set of clusters is associated with a channel estimate for FDD communications between the UE and a network node, wherein the cluster information is based at least in part on one or more measurements of the one or more RSs; and sending an indication of a total number of the set of clusters.

### INTRODUCTION

### Field of the Disclosure

Aspects of the present disclosure relate to wireless communications, and more particularly, to techniques for channel estimation for frequency division duplex (FDD) communications.

### Description of Related Art

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

One aspect provides a method for wireless communications by a user equipment (UE). The method includes obtaining one or more reference signals (RSs); sending, for each cluster of a set of clusters, an indication of cluster information, wherein the set of clusters is associated with a channel estimate for frequency division duplex (FDD) communications between the UE and a network node, wherein the cluster information is based at least in part on one or more measurements of the one or more RSs; and sending an indication of a total number of the set of clusters.

Another aspect provides a method for wireless communications by a network node. The method includes sending one or more RSs; obtaining, for each cluster of a set of clusters, an indication of cluster information, wherein the set of clusters is associated with a channel estimate for FDD communications between a UE and the network node, wherein the cluster information is based at least in part on one or more measurements of the one or more RSs; and obtaining an indication of a total number of the set of clusters.

Other aspects provide: one or more apparatuses operable, configured, or otherwise adapted to perform any portion of any method described herein (e.g., such that performance may be by only one apparatus or in a distributed fashion across multiple apparatuses); one or more non-transitory, computer-readable media comprising instructions that, when executed by one or more processors of one or more apparatuses, cause the one or more apparatuses to perform any portion of any method described herein (e.g., such that instructions may be included in only one computer-readable medium or in a distributed fashion across multiple computer-readable media, such that instructions may be executed by only one processor or by multiple processors in a distributed fashion, such that each apparatus of the one or more apparatuses may include one processor or multiple processors, and/or such that performance may be by only one apparatus or in a distributed fashion across multiple apparatuses); one or more computer program products embodied on one or more computer-readable storage media comprising code for performing any portion of any method described herein (e.g., such that code may be stored in only one computer-readable medium or across computer-readable media in a distributed fashion); and/or one or more apparatuses comprising one or more means for performing any portion of any method described herein (e.g., such that performance would be by only one apparatus or by multiple apparatuses in a distributed fashion). By way of example, an apparatus may comprise a processing system, a device with a processing system, or processing systems cooperating over one or more networks. An apparatus may comprise one or more memories; and one or more processors configured to cause the apparatus to perform any portion of any method described herein. In some examples, one or more of the processors may be preconfigured to perform various functions or operations described herein without requiring configuration by software.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of network entities and a user equipment (UE).

FIGS. 4A, 4B, 4C, and 4D depict various example aspects of data structures for a wireless communications network.

FIG. 5 depicts an example time-frequency resource allocation scheme for frequency division duplexing (FDD) communications.

FIG. 6A depicts an example antenna-transceiver architecture that may be employed at a UE.

FIG. 6B depicts another example antenna-transceiver architecture that may be employed at a UE.

FIG. 7 depicts an example cluster channel structure for channel estimation for FDD communications.

FIG. 8 depicts an example scheme for channel estimation with respect to a cluster.

FIG. 9 depicts a process flow for signaling related to channel estimation for FDD communications.

FIG. 10 depicts another process flow for signaling related to channel estimation for FDD communications.

FIG. 11 depicts a method for wireless communications.

FIG. 12 depicts another method for wireless communications.

FIG. 13 depicts aspects of an example communications device.

FIG. 14 depicts aspects of an example communications device.

### DETAILED DESCRIPTION

Aspects of the present disclosure provide apparatuses, methods, processing systems, and computer-readable mediums for channel estimation for frequency division duplexing (FDD) communications.

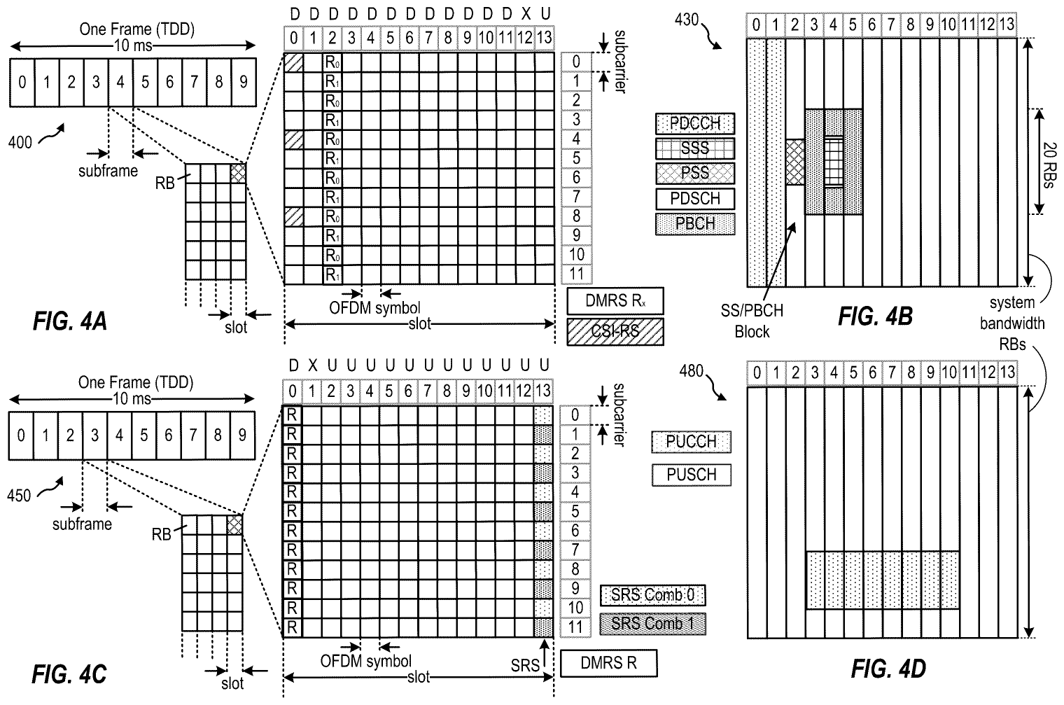

Certain wireless communications systems (e.g., 5G New Radio (5G-NR) systems) may use certain duplex modes to communicate via radio frequency (RF) carriers for uplink and downlink transmissions, such as time-division duplexing (TDD) and frequency-division duplexing (FDD). For TDD communications, a user equipment (UE) may communicate with a network entity (e.g., a base station) using the same RF carrier for downlink and uplink transmissions, where the downlink transmissions are communicated at different times than the uplink transmissions. For example, a UE may be configured with a TDD pattern that defines certain time periods for uplink and downlink transmissions, for example, as described herein with respect to FIGS. 4A and 4C.

For FDD communications, a UE may communicate with a network entity using separate RF carriers for uplink and downlink transmissions: an RF carrier for uplink transmissions and another RF carrier for downlink transmissions. In certain cases, the UE may transmit signals to the network entity and receive signals from the network entity at the same time via the separate downlink and uplink RF carriers.

For TDD systems, uplink-downlink channel reciprocity may be assumed, for example, due to the same RF carrier being used for uplink and downlink transmissions. Uplink-downlink channel reciprocity refers to a state where the uplink and downlink channels have (or are assumed to have) the same characteristics (e.g., signal propagation effects including attenuation, propagation time, scattering, fading, interference, noise, angle of arrival, angle of departure, or the like) in both the uplink and downlink directions, and thus, the amplitude, phase, signal quality, and/or signal strength of received signals on the downlink may be estimated based on measurements of the uplink, or vice versa. Uplink-downlink channel reciprocity allows a wireless communications device (e.g., a UE or network entity) to estimate the downlink channel based on measurements of the uplink channel, or vice versa. For example, a UE may receive reference signals (e.g., synchronization signaling) from the network entity, and the UE may estimate the uplink channel properties based on the measurements of the received reference signals, or vice versa. Uplink-downlink channel reciprocity can reduce the latency for certain operations, such as initial beam selection and/or beam refinement.

Technical problems for FDD communications may include, for example, channel estimation without channel reciprocity. For FDD systems, the uplink and downlink channels may not be reciprocal, for example, due to different RF carriers being used for uplink and downlink transmissions. The uplink and downlink channels may have different channel characteristics (e.g., signal propagation effects including attenuation, propagation delays, scattering, fading, interference, noise, or the like). As an example procedure to determine the channel characteristics of the downlink and uplink channels, the network entity may estimate the uplink channel based on uplink reference signals, and then the network entity may send the uplink channel information (or precoder information derived from uplink channel information) to the UE. The UE may estimate the downlink channel based on downlink reference signals, and then, the UE may send downlink channel information (or precoder information derived from downlink channel information) to the network entity. Accordingly, such a procedure may use a non-trivial amount of time to determine the uplink and downlink channel characteristics for FDD communications between a UE and a network entity.

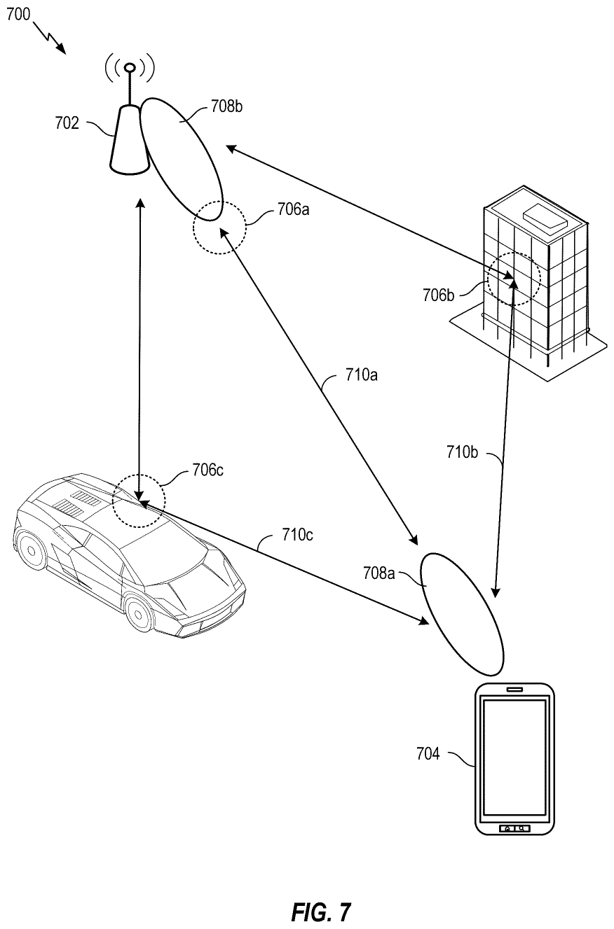

Aspects described herein may overcome the aforementioned technical problem(s), for example, by providing techniques for downlink-uplink channel estimation for FDD communications that may reduce the latency for determination of downlink-uplink channel estimates. In certain cases, a cluster channel structure may be used to model the uplink channel and downlink channel, for example, as further described herein with respect to FIG. 7. A cluster may refer to a set of multipath components that form a cluster or a set of rays between a UE and a network entity. A cluster may be characterized by one or more properties or parameters that may be applicable to (e.g., translatable between) the uplink channel and downlink channel, such as an angle of arrival, angle of departure, angular spread, delay spread, and gain information. For example, the angular and delay information for a cluster may be reciprocal for both the downlink and uplink channels due to the electromagnetic rays traversing the same propagation path on downlink as well as uplink. Thus, based on certain cluster information derived from downlink or uplink reference signals, the UE and/or the network entity may determine downlink-uplink channel estimation for FDD communications.

Certain techniques for channel estimation for FDD communications described herein may provide various beneficial technical effects and/or advantages. The techniques for channel estimation for FDD communications may enable improved wireless communications performance, such as reduced latencies, improved channel usage, and/or the like. In certain cases, the reduced latencies and/or improved channel usage may be attributable to the techniques for channel estimation that allow for determination of uplink and downlink channel estimates based on one of downlink reference signals or uplink reference signals without transmission of both uplink and downlink reference signals. Thus, the time used and/or channel used may be reduced due to reference signals being communicated in a single direction (for example, either a downlink or uplink direction).

In certain cases, the improved channel usage may be attributable to the techniques for channel estimation that allow for implicit feedback through transmission of uplink reference signals that are uplink channel precoded based on measurements of downlink reference signals. Thus, the implicit feedback via transmission of reference signals may use less channel overhead compared to explicit channel feedback as described herein.

In certain cases, the reduced latencies and/or improved channel usage may be attributable to the techniques for channel estimation that account for various transmit-receive architectures used at the UE, such as asymmetric transmit-receive architectures. Thus, the techniques for channel estimation may allow the UE and the network entity to be aligned in terms uplink and downlink channel estimates for a UE-specific transceiver architecture employed at the UE.

### Introduction to Wireless Communications Networks

The techniques and methods described herein may be used for various wireless communications networks. While aspects may be described herein using terminology commonly associated with 3G, 4G, 5G, 6G, and/or other generations of wireless technologies, aspects of the present disclosure may likewise be applicable to other communications systems and standards not explicitly mentioned herein.

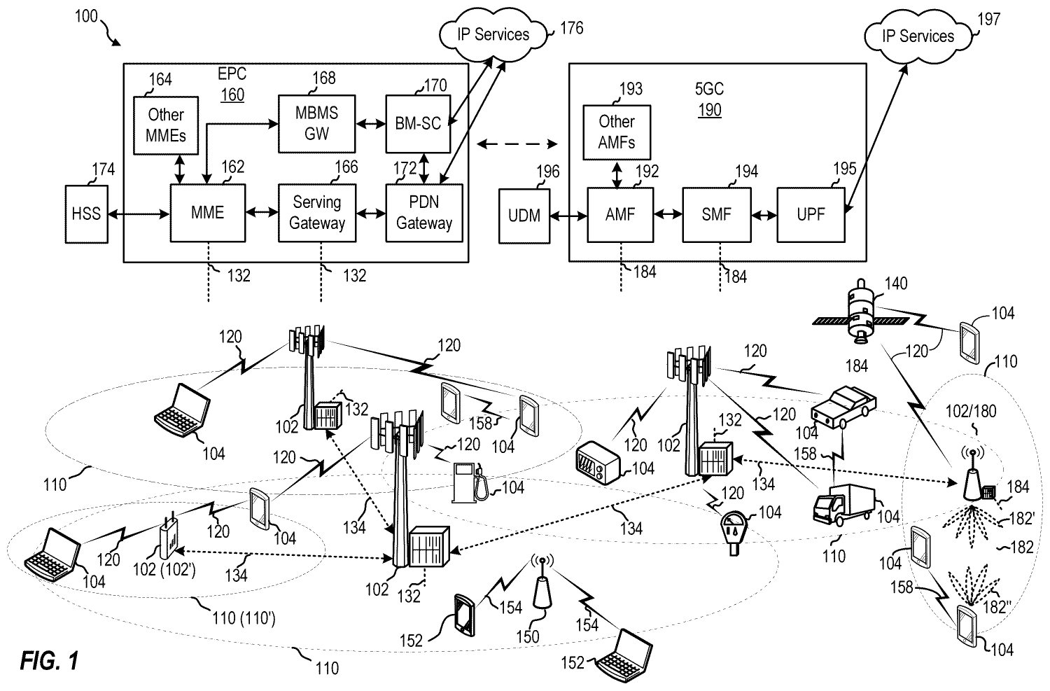

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). As such communications devices are part of wireless communications network 100, and facilitate wireless communications, such communications devices may be referred to as wireless communications devices. For example, various functions of a network as well as various devices associated with and interacting with a network may be considered network entities. Further, wireless communications network 100 may include terrestrial aspects, such as ground-based network entities (e.g., BSs 102), and non-terrestrial aspects (also referred to herein as non-terrestrial network entities). A non-terrestrial network entity may include satellite 140, which may be an example of an aerial or space-borne platform. In some examples, satellite 140 may include one or more network entities on-board (e.g., one or more BSs) capable of communicating with other network elements (e.g., terrestrial BSs) and UEs. For example, satellite 140 may be implemented according to a regenerative architecture (also referred to as a non-transparent architecture), and a gNB implemented at satellite 140 may implement higher-layer network functions. As another example, satellite 140 may be implemented according to a transparent architecture, and may perform a physical or other lower-layer repeater function for UEs and a network entity (such as a gateway associated with the satellite 140).

In the depicted example, wireless communications network 100 includes BSs 102, UEs 104, and one or more core networks, such as an Evolved Packet Core (EPC) 160 or a 5G Core (5GC) network 190, which interoperate to provide communications services over various communications links, including wired and wireless links. In some aspects, a core network, such as a 6G core, may implement a converged service-based architecture. In a converged service-based architecture, functions traditionally split between a core network (such as 5GC network 190) and a radio access network (RAN) (such as BS 102) may be implemented at a single network entity. For example, a mobility network entity may perform both core network functions and RAN functions related to mobility of UEs 104 attached to the wireless communications network 100. “Network entity” can refer to a BS 102, a network entity of EPC 160 or 5GC network 190, or a network entity of a converged service-based architecture.

FIG. 1 depicts various example UEs 104. UE 104 may include a cellular phone, a smart phone, a session initiation protocol (SIP) phone, a laptop, a personal digital assistant (PDA), a satellite radio, a Global Positioning System device, a multimedia device, a video device, a digital audio player, a camera, a game console, a tablet, a smart device, a wearable device, a vehicle, an electric meter, a gas pump, a kitchen appliance, a healthcare device, an implant, a sensor/actuator, a display, an Internet of Things (IoT) device, an always on (AON) device, an edge processing device, a data center, or another similar device. A UE 104 may also be referred to as a mobile device, a wireless device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. A communications link 120 between a BS 102 and a UE 104 may include uplink (UL) (also referred to as reverse link) transmissions from a UE 104 to a BS 102 and/or downlink (DL) (also referred to as forward link) transmissions from a BS 102 to a UE 104. A communications link 120 may use multiple-input and multiple-output (MIMO) antenna technology, including spatial multiplexing, beamforming, and/or transmit diversity in various aspects.

A BS 102 may include a NodeB, an enhanced NodeB (eNB), a next generation enhanced NodeB (ng-eNB), a next generation NodeB (gNB or gNodeB), an access point, a base transceiver station, a radio base station, a radio transceiver, a transceiver function, a transmission reception point (TRP), a radio unit (RU), a distributed unit (DU), or the like. A given BS 102 may provide communications coverage for a coverage area 110, which may sometimes be referred to as a cell, and which may overlap another coverage area 110 (e.g., a small cell provided by a BS 102′) may have a coverage area 110′ that overlaps the coverage area 110 of a macro cell). A BS 102 may, for example, provide communications coverage for a macro cell (covering a relatively large geographic area), a pico cell (covering a relatively smaller geographic area, such as a sports stadium), a femto cell (covering a relatively smaller geographic area, such as a home), or another type of cell.

The term “cell” may refer to a portion, partition, or segment of wireless communication coverage served by a network entity within a wireless communications network 100. A cell may have geographic characteristics, such as a geographic coverage area, as well as radio frequency characteristics, such as time and/or frequency resources dedicated to the cell. For example, a specific geographic coverage area may be covered by multiple cells employing different frequency resources (e.g., bandwidth parts) and/or different time resources. As another example, a specific geographic coverage area may be covered by a single cell. In some contexts (e.g., a carrier aggregation scenario and/or multi-connectivity scenario), the terms “cell” or “serving cell” may refer to or correspond to a specific carrier frequency (e.g., a component carrier) used for wireless communications, and a “cell group” may refer to or correspond to multiple carriers used for wireless communications. As examples, in a carrier aggregation scenario, a UE may communicate on multiple component carriers corresponding to multiple (serving) cells in the same cell group, and in a multi-connectivity (e.g., dual connectivity) scenario, a UE may communicate on multiple component carriers corresponding to multiple cell groups.

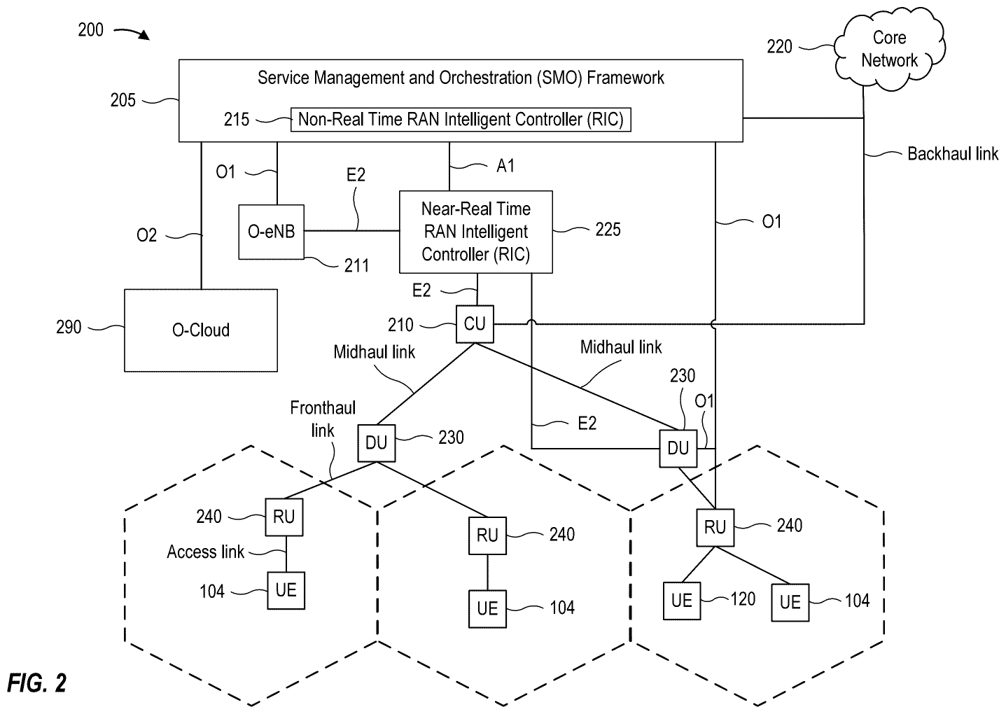

While BSs 102 are depicted in various aspects as unitary communications devices, BSs 102 may be implemented in various configurations. For example, one or more components of a base station may be disaggregated, including a central unit (CU), one or more DUs, one or more RUs, a Near-Real Time (Near-RT) RAN Intelligent Controller (RIC), or a Non-Real Time (Non-RT) RIC, to name a few examples. In another example, various aspects of a base station may be virtualized. A base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. Implementing a base station in this fashion may provide efficiency gains by enabling cloud-based implementation of certain (e.g., non-time-sensitive) higher-layer functions while physical-layer or other lower-layer functions can be implemented at or in proximity to a geographic coverage area of a corresponding cell. In some aspects, a base station including components that are located at various physical locations may be referred to as having a disaggregated RAN architecture, such as an Open RAN (O-RAN) or Virtualized RAN (VRAN) architecture. FIG. 2 depicts and describes an example disaggregated RAN architecture.

Different BSs 102 within wireless communications network 100 may also be configured to support different radio access technologies, such as 3G, 4G, 5G, and/or 6G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or the 5GC 190) with each other over third backhaul links 134 (e.g., an X2 or XN interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, the Third Generation Partnership Project (3GPP) currently defines Frequency Range 1 (FR1) as including 410 MHz-7125 MHz, which is often referred to (interchangeably) as “Sub-6 GHz”. Similarly, 3GPP currently defines Frequency Range 2 (FR2) as including 24,250 MHz-71,000 MHz, which is sometimes referred to (interchangeably) as a “millimeter wave” (“mmW” or “mmWave”). In some cases, FR2 may be further defined in terms of sub-ranges, such as a first sub-range FR2-1 including 24,250 MHz-52,600 MHz and a second sub-range FR2-2 including 52,600 MHz-71,000 MHz. A base station configured to communicate using mmWave/near mmWave radio frequency bands (e.g., a mmWave base station such as BS 180) may utilize beamforming (e.g., 182) with a UE (e.g., 104) to improve path loss and range.

A communications links 120 may be through one or more carriers, which may have different bandwidths (e.g., 5 MHz, 10 MHz, 15 MHz, 20 MHz, 100 MHz, 400 MHz, and/or other bandwidths), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., base station 180 in FIG. 1) may utilize beamforming (indicated by reference number 182) with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may perform beam training to determine suitable receive and transmit directions for each of BS 180 and UE 104. Notably, the transmit and receive directions for BS 180 may or may not be the same. Similarly, the transmit and receive directions for UE 104 may or may not be the same.

Wireless communications network 100 may include a Wi-Fi access point (AP) 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. In some examples, D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH). D2D communications link 158 may be implemented using a variety of technologies, such as a radio access technology (e.g., 5G, ProSe sidelink), a WiFi technology, a Bluetooth technology, or the like.

EPC 160 may include various functional components, such as a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172. MME 162 may be in communication with a Home Subscriber Server (HSS) 174. MME 162 is a control node that processes signaling between the UEs 104 and the EPC 160. Generally, MME 162 provides bearer and connection management.

Generally, user Internet protocol (IP) packets are transferred through Serving Gateway 166. Serving gateway 166 is connected to PDN Gateway 172. PDN Gateway 172 provides UE IP address allocation as well as other functions. PDN Gateway 172 and BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, such as an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and the 5GC 190. AMF 192 provides, for example, quality of service (QoS) flow and session management.

IP packets are transferred through UPF 195, which is connected to the IP Services 197. UPF 195 may provide UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a core network entity, or a sidelink node, to name a few examples.

FIG. 2 depicts an example disaggregated base station 200 architecture. The disaggregated base station 200 architecture may include one or more CUs 210 that can communicate directly with a core network 220 or other CUs 210 via a backhaul link (such as backhaul link 134), or indirectly with the core network 220 through one or more disaggregated base station units (such as a Near-Real Time (Near-RT) RAN Intelligent Controller (RIC) 225 via an E2 link, a Non-Real Time (Non-RT) RIC 215 associated with a Service Management and Orchestration (SMO) Framework 205, or both). A CU 210 may communicate with one or more DUs 230 via respective midhaul links, such as an F1 interface. The DUs 230 may communicate with one or more RUs 240 via respective fronthaul links. The RUs 240 may communicate with respective UEs 104 via one or more radio frequency (RF) access links (such as communication link 120). In some implementations, a UE 104 may be simultaneously served by multiple RUs 240.

Each of the units, e.g., the CUS 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or a processor or controller providing instructions to the interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter, or a transceiver (such as a RF transceiver), configured to receive or transmit signals, or both, over a wireless transmission medium.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230 for network control and signaling.

The DU 230 may be or correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (IFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUS 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more DUs 230 and/or one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via 01) or via creation of RAN management policies (such as A1 policies).

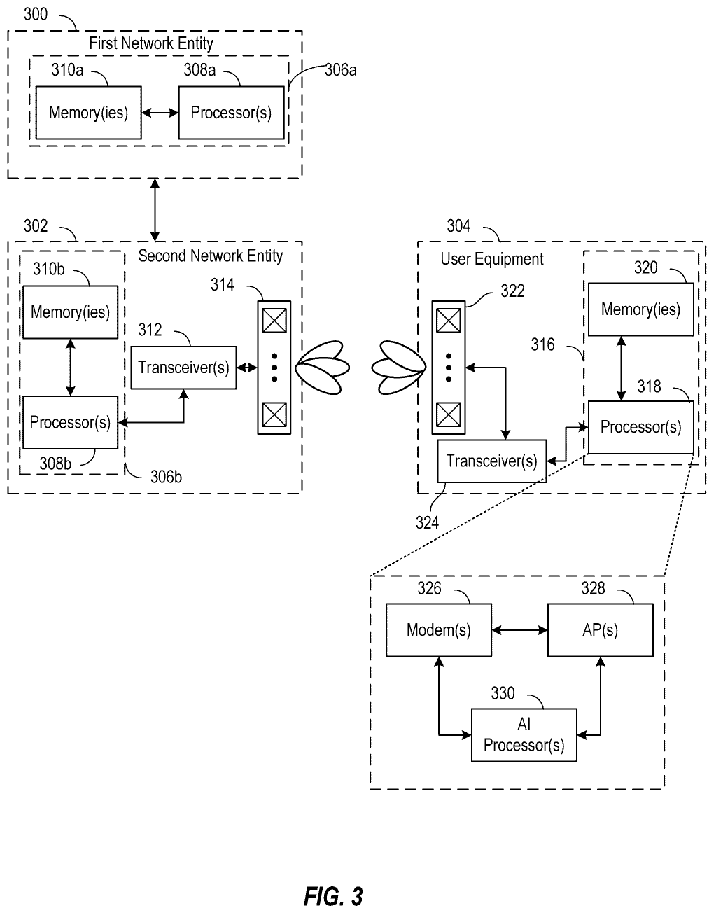

FIG. 3 depicts aspects of network entities 300 and 302 and a UE 304.

FIG. 3 includes a first network entity 300 and a second network entity 302. In some examples, first network entity 300 may be an example of a CU 210 or a DU 230. In some examples, second network entity 302 may be an example of a DU 230 or an RU 240. First network entity 300 and second network entity 302 may communicate with one another via a communications link, such as a midhaul link. In some examples, first network entity 300 and second network entity 302 may be implemented at a same BS (e.g., BS 102). For example, first network entity 300 and second network entity 302 may be co-located. In some other examples, first network entity 300 may be implemented separately from second network entity 302. For example, first network entity 300 may be implemented as a function (e.g., one or more processes) running on a server, such as in a cloud (e.g., a public or private cloud). As another example, first network entity 300 may be implemented as a virtual computing instance (e.g., virtual machine, container, etc.) or as a physical server.

First network entity 300 and second network entity 302 each include a processing system 306, illustrated as “processing system 306a” at first network entity 300 and “processing system 306b” at second network entity 302. For example, first network entity 300 and second network entity 302 may include one or more chips, system-on-chips (SoCs), system-in-packages (SiPs), chipsets, packages, or devices that individually or collectively constitute or comprise a processing system 306. A processing system 306 includes one or more processors 308 (illustrated as “processor(s) 308a” and “processor(s) 308b”) and one or more memories 310 (illustrated as “memory(ies) 310a” and “memory(ies) 310b”) coupled to the one or more processors 308. The one or more processors 308 may include one or multiple processors, microprocessors, processing units (such as central processing units (CPUs), graphics processing units (GPUs), neural processing units (NPUs) (also referred to as neural network processors or deep learning processors (DLPs)) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (any one or more of which may be generally referred to herein individually as a “processor” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

In some aspects, the processing system 306 may perform processing (such as digital signal processing) of data, control information, or signals received or transmitted by a network entity. For example, the processing system 306 may include a coder, a decoder, a multiplexer, a demultiplexer, a transmit MIMO processor, a transmit processor, a receive processor, a receive MIMO detector, an automatic gain control component, or the like.

The one or more memories 310 may include one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). The one or more memories 310 may store data and program code for first network entity 300 and/or second network entity 302.

As further shown, second network entity 302 includes one or more transceivers 312 (illustrated as “transceiver(s) 312”). The one or more transceivers 312 may perform processing related to implementing physical layer (e.g., radio, air interface) communication with other devices such as UE 304. The one or more transceivers 312 may include one or more radio frequency (RF) components, such as an RF transceiver, a front-end module (e.g., an RF front-end (RFFE)), or the like. For example, the one or more transceivers 312 may include a transmit path (also referred to as a transmit chain), a receive path (also referred to as a receive chain), and/or an interface with one or more antennas 314.

The one or more antennas 314 may perform wireless transmission and reception of signals. The one or more antennas 314 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 3.

UE 304 may be an example of UE 104. As shown, UE 304 includes a processing system 316. For example, UE 304 may include one or more chips, SoCs, SiPs, chipsets, packages, or devices that individually or collectively constitute or comprise a processing system 316. A processing system 316 includes one or more processors 318, and one or more memories 320 coupled to the one or more processors 318. Further, UE 304 includes one or more antennas 322, one or more transceivers 324, and/or other components that enable wireless transmission and reception of data.

The one or more processors 318 may include one or multiple processors, microprocessors, processing units (such as CPUs, GPUs, NPUs (also referred to as neural network processors or DLPs) and/or DSPs), processing blocks, ASICs, PLDs (such as FPGAs), or other discrete gate or transistor logic or circuitry (any one or more of which may be generally referred to herein individually as a “processor” or collectively as “the processor” or “the processor circuitry”). One or more of the processors may be individually or collectively configurable or configured to perform various functions or operations described herein. In some aspects, the processing system 316 may perform processing (such as digital signal processing) of data, control information, or signals received or transmitted by a network entity. For example, the processing system 316 may include a coder, a decoder, a multiplexer, a demultiplexer, a transmit MIMO processor, a transmit processor, a receive processor, a receive MIMO detector, an automatic gain control component, or the like.

As shown, in some examples, the one or more processors 318 may include one or more modems 326, one or more application processors (APs) 328, one or more AI processors 330, a combination thereof, and/or another form of processor.

The one or more modems 326 may include a digital signal processor that converts information into a waveform for analog signal transmission (e.g., via modulation) and/or converts the waveform of a received signal into information (e.g., via demodulation). The one or more modems 326 may process information or waveforms in connection with signal transmission or reception. For example, the one or more modems 326 may include a coder, a decoder, a multiplexer, a demultiplexer, a transmit MIMO processor, a transmit processor, a receive processor, a receive MIMO detector, an automatic gain control component, or the like.

The one or more APs 328 may perform processing relating to an operating system and/or a higher layer application of the UE 304. For example, the one or more APs 328 may provide a higher-level operating system (HLOS), software, audio or video processing, graphics processing, or the like. In some examples, the one or more APs 328 may be a data source (e.g., for transmissions) or a data sink (e.g., for receptions).

The one or more transceivers 324 may perform processing related to implementing physical layer (e.g., radio, air interface) communication with other devices such as other UEs 304 or second network entity 302. The one or more transceivers 324 may include one or more RF components, such as an RF transceiver, a front-end module (e.g., an RFFE), or the like. For example, the one or more transceivers 324 may include a transmit path (also referred to as a transmit chain), a receive path (also referred to as a receive chain), and/or an interface with one or more antennas 322.

The one or more antennas 322 may perform wireless transmission and reception of signals. The one or more antennas 322 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 3.

For an example downlink transmission by second network entity 302, the processing system 306 (e.g., a transmit processor) may receive data and/or control information. The control information may be for the physical broadcast channel (PBCH), physical control format indicator channel (PCFICH), physical hybrid automatic repeat request (HARQ) indicator channel (PHICH), physical downlink control channel (PDCCH), group common PDCCH (GC PDCCH), and/or others. The data may be for the physical downlink shared channel (PDSCH), in some examples.

The processing system 306 (e.g., a transmit processor) may process (e.g., encode and symbol map) the data and control information to obtain data symbols and control symbols, respectively. The processing system 306 may also generate reference symbols, such as for the primary synchronization signal (PSS), secondary synchronization signal (SSS), PBCH demodulation reference signal (DMRS), or channel state information reference signal (CSI-RS).

The processing system 306 (e.g., a TX MIMO processor) may perform spatial processing (e.g., precoding) on the data symbols, the control symbols, and/or the reference symbols, if applicable, and may provide output symbol streams to one or more modulators of the processing system 306. The one or more modulators may process one or more respective output symbol streams to obtain an output sample stream. The one or more transceivers 312 may process (e.g., convert to analog, amplify, filter, and upconvert) the output sample stream to obtain a downlink signal. Second network entity 302 may transmit the downlink signal via the one or more antennas 314.

In order to receive the downlink transmission at UE 304 (or a sidelink transmission from another UE), the one or more antennas 322 may receive the downlink signal and may provide received signals to the one or more transceivers 324. The one or more transceivers 324 may condition (e.g., filter, amplify, downconvert, and digitize) the received signals to obtain input samples. The one or more transceivers 324 and/or the processing system 316 may further process the input samples to obtain received symbols.

The processing system 316 (e.g., modem 326, an RX MIMO detector) may obtain the received symbols, perform MIMO detection on the received symbols if applicable, and provide detected symbols. The processing system 316 (e.g., a modem 326, a receive processor) may process (e.g., de-interleave and decode) the detected symbols. The processing system 316 may provide decoded data for the UE 304 (e.g., to an AP 328) and/or decoded control information (e.g., to a controller/processor of the processing system 316).

For an example uplink transmission or a sidelink transmission from UE 304, the processing system 316 (e.g., modem 326, a transmit processor) may receive and process data and/or control information to obtain a set of symbols for transmission. The data may be for the physical uplink shared channel (PUSCH), and may be received from a data source such as the AP 328. The control information may be for the physical uplink control channel (PUCCH), and may be received, for example, from a controller/processor of the processing system 316. The processing system 316 (e.g., a modem 326, the transmit processor) may also generate reference symbols for a reference signal (e.g., for a sounding reference signal (SRS), a demodulation reference signal, a phase tracking reference signal, or the like). In some examples, the symbols and/or reference signals may be precoded by the processing system 316 (e.g., modem 326, a TX MIMO processor), further processed by the one or more transceivers 324 (e.g., for SC-FDM), and transmitted to second network entity 302.

At second network entity 302, the uplink signals from UE 304 may be received by the one or more antennas 314, conditioned by the one or more transceivers 312 (e.g., filtered, amplified, downconverted, and digitized), detected (e.g., by the processing system 306b such as a modem and/or an RX MIMO detector), and further processed by the processing system 306b (e.g., a modem and/or a receive processor) to obtain decoded data and control information sent by UE 304. The processing system 306b may provide the decoded data and the decoded control information (such as to a controller/processor of the processing system 306b, an AP, first network entity 300, or another entity).

In various aspects, a wireless communication device, such as first network entity 300, second network entity 302, BS 102, UE 104, or UE 304 may be described as sending, transmitting, obtaining, or receiving various types of data associated with the methods described herein. In these contexts, “transmitting” or “sending” may refer to various mechanisms of outputting data, such as outputting data from a processing system, one or more memories, one or more transceivers, one or more antennas, and/or other aspects described herein. For example, “sending” or “transmitting” by a device may include sending (such as wirelessly, via a wired connection, or both) to a recipient directly or via another device. As another example, “sending” or “transmitting” may include sending internally to a device (such as the UE 304, first network entity 300, or second network entity 302) by a process to memory. “Receiving” or “obtaining” may refer to various mechanisms of obtaining data, such as obtaining data from the processing system, one or more memories, one or more transceivers, one or more antennas, and/or other aspects described herein. For example, “receiving” or “obtaining” by a device may include obtaining (such as wirelessly, via a wired connection, or both) from a recipient directly or via another device. As another example, “receiving” or “obtaining” may include obtaining internally to a device (such as the UE 304, first network entity 300, or second network entity 302) by a process from memory. As used herein, “communicating” by a device may include sending, obtaining, receiving, and/or transmitting a communication. “Communicating” can refer to communication with another device or internal communication of the device.

In various aspects, the processing system 306 or the processing system 316 may include one or more AI processors (such as AI processor 330 of the processing system 316). An AI processor may perform AI processing. The AI processor may include AI accelerator hardware or circuitry such as one or more neural processing units (NPUs), one or more neural network processors, one or more tensor processors, one or more deep learning processors, etc. As an example, the AI processor may perform AI-based beam management, AI-based channel state feedback (CSF), AI-based antenna tuning, and/or AI-based positioning (e.g., non-line of sight positioning prediction). In some cases, at the UE 104, the AI processor may process feedback generated by the UE 304 (e.g., CSF) using hardware accelerated AI inferences and/or AI training. In some cases, at the second network entity 302, the AI processor may decode compressed CSF from the UE 304, for example, using a hardware accelerated AI inference associated with the CSF. In certain cases, the AI processor may perform certain RAN-based functions including, for example, network planning, network performance management, energy-efficient network operations, etc.

FIGS. 4A, 4B, 4C, and 4D depict aspects of data structures for a wireless communications network, such as wireless communications network 100 of FIG. 1.

FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. One or more subcarriers may be modulated with data. Modulation symbols may be sent in the frequency domain with OFDM and/or in the time domain with SC-FDM.

In some examples, a wireless communications frame structure may be implemented using frequency division duplexing (FDD). In FDD, some subcarriers may be configured for DL communication, and other subcarriers (which may overlap in time with the DL subcarriers) may be configured for UL communication. In some other examples, wireless communications frame structures may be implemented using time division duplexing (TDD). In TDD, for a particular set of subcarriers, some subframes are configured for DL communication and other subframes are configured for UL communication.

In FIGS. 4A and 4C, the wireless communications frame structure is implemented using TDD. “D” indicates DL time resources, “U” indicates UL time resources, and “X” indicates flexible time resources for use or later reconfiguration for either DL or UL communication. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 12 or 14 symbols, depending on the cyclic prefix (CP) type (e.g., 12 symbols per slot for an extended CP or 14 symbols per slot for a normal CP). Subframes may also include mini-slots, which generally have fewer symbols than an entire slot. Other wireless communications technologies may have a different frame structure and/or different channels.

In certain aspects, the number of slots within a subframe (e.g., a slot duration in a subframe) is based on a numerology. A numerology may define a frequency domain subcarrier spacing and symbol duration, and may be configured for a given bandwidth part, carrier, cell, or network entity. In certain aspects, given a numerology μ, there are 2^{μ} slots per subframe. Thus, numerologies (μ) 0 to 6 may allow for 1, 2, 4, 8, 16, 32, and 64 slots, respectively, per subframe. In some cases, an extended CP (e.g., 12 symbols per slot) may be used with a specific numerology, such as numerology μ=2 allowing for 4 slots per subframe. The subcarrier spacing and symbol length/duration are a function of the numerology. The subcarrier spacing may be equal to 2^{μ}×15 kHz. As an example, the numerology μ=0 corresponds to a subcarrier spacing of 15 kHz, and the numerology μ=6 corresponds to a subcarrier spacing of 960 kHz. The symbol length/duration is inversely related to the subcarrier spacing. FIGS. 4A, 4B, 4C, and 4D provide an example of a slot format having 14 symbols per slot (e.g., a normal CP) and a numerology μ=2 with 4 slots per subframe. In such a case, the slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as a physical RB (PRB)) that extends across, for example, 12 consecutive subcarriers. The resource grid is divided into multiple resource elements (REs). An RE may include a single subcarrier in the frequency domain and a single symbol in the time domain. The number of bits carried by each RE depends on the modulation scheme including, for example, quadrature phase shift keying (QPSK) or quadrature amplitude modulation (QAM).

As illustrated in FIG. 4A, some of the REs carry reference (pilot) signals (shown as “RS”) for a UE (e.g., UE 104 of FIGS. 1 and 3). The RS may include a demodulation RS (DMRS) and/or a channel state information reference signals (CSI-RS) for channel estimation at the UE. The RS may additionally or alternatively include a beam measurement RS (BRS), a beam refinement RS (BRRS), and/or a phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block (SSB), and in some cases, referred to as a synchronization signal block (SSB). The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as “R” for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Example Frequency Division Duplexing Mode

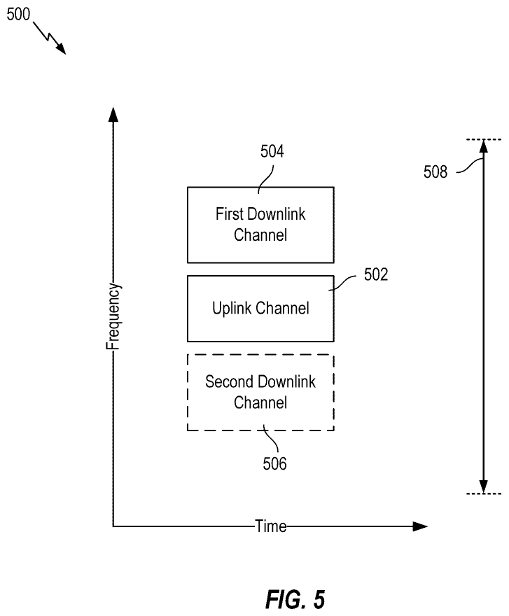

FIG. 5 depicts an example time-frequency resource allocation scheme 500 for FDD communications. In this example, a UE may be allocated a set of uplink resources (hereinafter “the uplink channel 502”), a first set of downlink resources (hereinafter “the first downlink channel 504”), and in some cases, a second set of downlink resources (hereinafter “the second downlink channel 506”), for FDD communications in a transmission occasion (e.g., a slot). The uplink channel 502, the first downlink channel 504, and/or the second downlink channel 506 may enable full-duplex communications between the UE and a network entity. For example, the UE may communicate downlink and uplink signaling in the transmission occasion via the uplink channel 502, the first downlink channel 504, and/or the second downlink channel 506.

Each of the uplink channel 502, the first downlink channel 504, and/or the second downlink channel 506 may include one or more time-frequency resources. In certain aspects, each of the uplink channel 502, the first downlink channel 504, and/or the second downlink channel 506 may occupy a subband (e.g., a bandwidth part (BWP)) of a carrier 508 defined by a frequency bandwidth or frequency range. The carrier 508 may be a frequency range of one or more operating bands specified for wireless communications, such as an operating band of FR1 and/or FR2.

In certain cases, the uplink channel 502 may be arranged between the first downlink channel 504 and the second downlink channel 506 in the frequency domain, as depicted. In certain aspects, a first guard band may be arranged between the uplink channel 502 and the first downlink channel 504 in the frequency domain. A second guard band may be arranged between the uplink channel 502 and the second downlink channel 506 in the frequency domain. Note that the frequency domain arrangement of the uplink channel 502, the first downlink channel 504, and the second downlink channel 506 is an example arrangement. FDD communications may employ other suitable frequency domain arrangements of the uplink channel 502, the first downlink channel 504, and/or the second downlink channel 506.

In certain aspects, the uplink channel 502, the first downlink channel 504, and/or the second downlink channel 506 communications may be configured across multiple carriers (e.g., the carrier 508). For example, a UE may be allocated a downlink channel in a first carrier and an uplink channel in a second carrier.

### Example Antenna-Transceiver Architectures

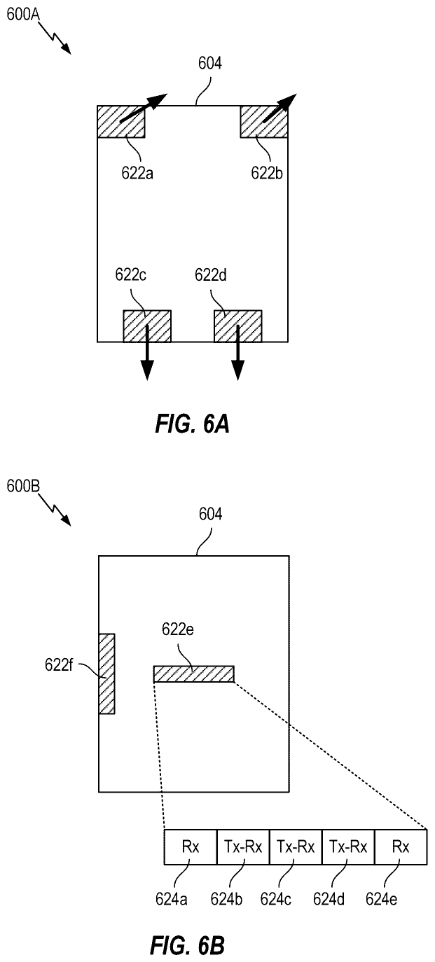

FIG. 6A depicts an example antenna-transceiver architecture 600A that may be employed at a UE 604. In this example, the UE 604 may include a plurality of antennas 622a-d. The antennas 622a-d may include a first set of antennas that can be used for transmission and reception, and a second set of antennas that can be used for reception. For example, the first set of antennas (e.g., the antennas 622a, 622c) may be coupled to RF circuitry that includes a transmit path and a receive path. The second set of antennas (e.g., the antennas 622b, 622d) may be coupled to RF circuitry that includes a receive path. Accordingly, the UE 604 may have an asymmetric transmit-receive antenna architecture with more receive antennas (e.g., the antennas 622a-d) than transmit antennas (e.g., the antennas 622a, 622c). In certain cases, the second set of antennas may be used as receive antenna(s), for example, due to the antennas being tuned to certain frequencies specified for downlink communications, such as a downlink channel specified for FDD communications.

For channel state characterization via SRS transmission(s), certain UEs (such as the UE 604) may be capable of switching a transmit path between receive antennas (such as the antennas 622b, 622d). The UE may notify a network entity of its SRS transmit port switching capability or if the UE is capable of simultaneously transmitting the SRS from each antenna. For example, the UE may include switch circuitry that enables the UE to selectively couple the second set of antennas to a transmit chain to transmit SRS(s) via the second set of antennas. With respect to the SRS transmit port switching capability of a UE, TIR2 may indicate that the UE has 1 transmit path (T1) that can switch between 2 receive antenna ports (R2). TIR4 may indicate that the UE has 1 transmit path that can switch between 4 receive antenna ports. T2R4 may indicate that the UE has 2 transmit paths that can switch between 4 receive antenna ports. As an example, the UE 604 may have a SRS transmit port switching capability of T2R4.

FIG. 6B depicts another example antenna-transceiver architecture 600B that may be employed at a UE 604. In this example, the UE 604 may include a plurality of antenna arrays 622e, 622f, for example, configured for certain high frequency communications, such as mmWave communications. An antenna array may include a plurality of antenna elements 624a-e arranged in an array, such as a linear array of antenna elements, a rectangular array of antenna elements, or the like. In certain cases, an antenna array may have more receive antenna elements than transmit antenna elements. For example, the antenna array 622e may have a set of transmit-receive antenna elements (e.g., antenna elements 624b, 624c, 624d) and a set of receive antenna elements (e.g., antenna elements 624a, 624c). As shown, the set of transmit-receive antenna elements may be arranged between the antenna elements of the set of receive antenna elements.

As further described herein, aspects of the present disclosure provide techniques for channel estimation for FDD communication that account for various transmit-receive architectures used at the UE, such as asymmetric transmit-receive architectures of FIG. 6A and/or FIG. 6B.

### Aspects Related to Channel Estimation for FDD Communications

Aspects of the present disclosure provide techniques for downlink-uplink channel estimation for FDD communications.

FIG. 7 depicts an example cluster channel structure 700 for channel estimation for FDD communications. In this example, a UE 704 may be in communication with a network entity 702 via FDD communications, for example, as described herein with respect to FIG. 5. The uplink and downlink channels for FDD communications between the UE 704 and the network entity 702 may be characterized in terms of a set of clusters (or rays over a certain angular spread), for example, including the clusters 706a, 706b, 706c. The uplink and downlink channels may be estimated using a cluster-based channel model, for example, including the clusters 706a, 706b, 706c. The set of clusters may be associated with a channel estimate for FDD communications. For example, each of the clusters may be a component of the channel between the UE 704 and the network entity 702. Accordingly, a channel estimate may be formed based on the set of clusters and/or corresponding cluster information.

A cluster (such as the first cluster 706a or the second cluster 706b) may be formed by or include at least a portion of a signal propagation path between the UE 704 and the network entity 702. A cluster may be or include a set of multipath components for the portion of the signal propagation path between the UE 704 and the network entity 702. The set of multipath component(s) may form a cluster or ray in a specific location, for example, corresponding to a reflection, scattering, or diffraction. In certain aspects, a signal communicated between the UE 704 and the network entity (for example, via a transmit-receive beam pair, for example, including beams 708a, 708b) may have multipath propagation, which may correspond to propagation over multiple clusters. For example, the first cluster 706a may be associated with a line-of-sight signal propagation path (e.g., the path 710a), and/or the cluster(s) 706b, 706c may be associated with the non-line-of-sight signal propagation path(s) (e.g., the paths 710b, 710c). In certain cases, a cluster may be formed via line-of-sight signal propagation and/or non-line-of-sight signal propagation (such as through reflection and/or diffraction). As an example, a cluster may be formed between a TRP (such as the network entity 702) and the UE 704 (such as the first cluster 706a), for example, based on a line-of-sight path (such as the first cluster 706a), or based on reflection or diffraction (such as the second cluster 706b and the third cluster 706c).

A cluster may be characterized in terms of one or more properties associated with the signal propagation path between the UE 704 and the network entity 702. The properties may include, for example, angular information, delay information, gain information, and/or frequency information (e.g., Doppler shift and/or Doppler spread) associated with the signal propagation of the cluster. The properties may include, for example, an azimuth angle of arrival (AoA), a zenith angle of arrival (ZoA), an azimuth angle of departure (AoD), a zenith angle of departure (ZoD), angular spread (e.g., in terms of azimuth and/or elevation), delay spread, and/or gain information (e.g., estimated received signal amplitude and phase). In certain aspects, the AoA, AoD, and/or the angular spread maybe expressed in a certain coordinate system, such as a spherical coordinate system. For example, the AoA, AoD, and/or angular spread may include an azimuth angle and/or a zenith or elevation angle. The delay spread may be or include a root-mean squared delay spread.

Under a cluster channel structure, certain cluster information may be assumed to be the same (or reciprocal) for the downlink and uplink channels, such as the angular information (e.g., AoA, ZoA, AoD, ZoD, angular spread, or the like) and/or the delay information of each path/ray in a cluster. The angular information and/or the delay information may be assumed to be the same, for example, due to the downlink and uplink channels using relatively close frequencies, such as downlink and uplink carriers within the same operating band or adjacent bands.

For the cluster channel structure, certain cluster information may be different between the downlink and uplink channels, such as the gain information and/or phase information of a cluster. For example, the received signal amplitudes for uplink and downlink signaling may be different due to certain frequency dependent signal propagation effects, such as scattering, fading, interference, noise, and/or the like. Thus, the channel matrices (e.g., H_{DL} and H_{UL}) may be different for the downlink and uplink channels.

As further described herein, a relationship (e.g., certain adjustment factor(s)) between the downlink and uplink channels along with the reciprocal information may be used to determine a downlink channel estimate based on measurement(s) of uplink signaling, or vice versa. The measurements may include, for example, received signal strength, received signal quality, received signal phase, angular information, delay information, gain information, and/or the like. For example, the downlink channel may be determined based on measurements of downlink signaling, and then, the uplink channel may be estimated based on the downlink channel. The reciprocal information may be leveraged with the relationship between the downlink and uplink channels (such as mismatches between uplink-downlink RF circuitry or the like) to convert a downlink channel matrix into an uplink channel matrix, or vice versa.

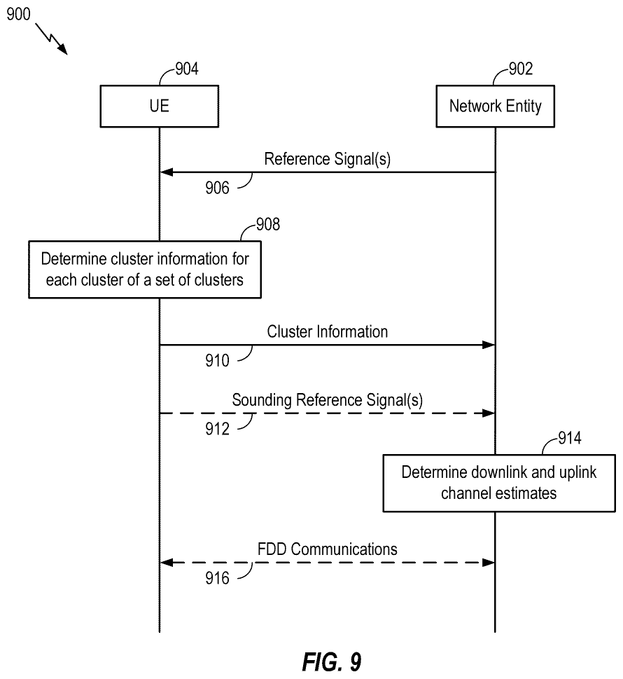

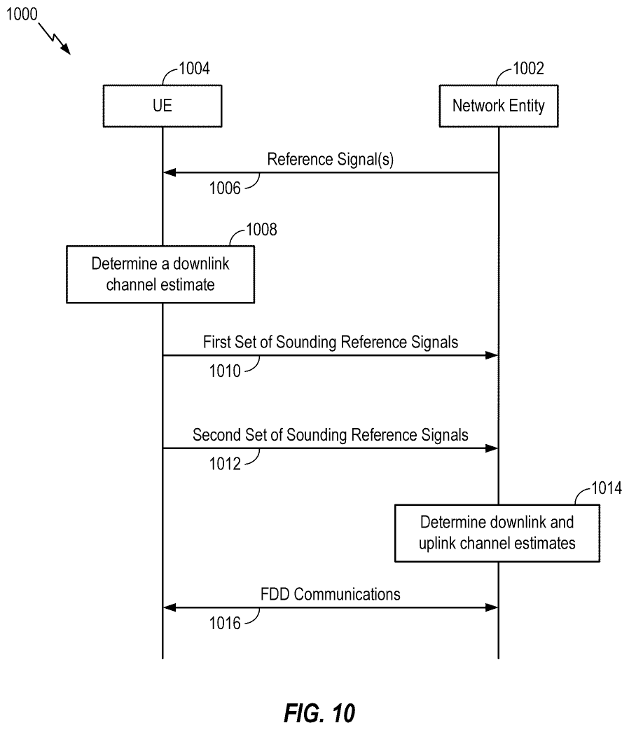

The UE may provide, to the network entity, feedback based on the cluster channel structure, for example, as further described herein with respect to FIGS. 9 and 10. As an example, the UE may determine certain cluster information associated with each of the clusters. The UE may send the cluster information to the network entity. The cluster information may enable the network entity to determine a relationship between the downlink and uplink channels and convert an uplink channel estimate to a downlink channel estimate, or vice versa. Accordingly, the techniques for the cluster-based channel estimation for FDD communications may enable reduced latencies, improved channel usage, and/or the like.

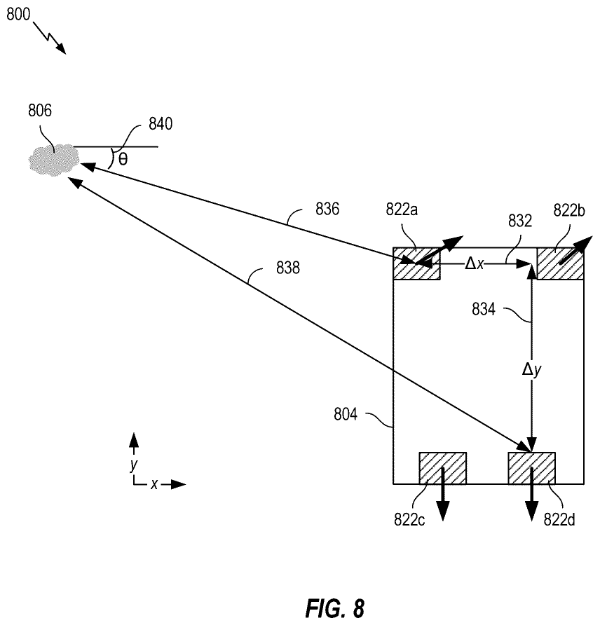

FIG. 8 depicts an example scheme 800 for channel estimation with respect to a cluster 806, such as a cluster of FIG. 7. In this example, a UE 804 may include a plurality of antennas 822a-d. In certain cases, the UE 804 may have the antenna-transceiver architecture as described herein with respect to FIG. 6A. Let h_{DL,0}, h_{DL,1}, h_{DL,2} and h_{DL,3} denote the downlink channel estimates (e.g., the downlink channel matrices) associated with the antennas 822a-d, respectively.

In certain cases, the UE 804 may determine the downlink channel estimates (e.g., h₀, h₁, h₂, and h₃) for all of the receive antennas 822a-d, for example, based on measurements of reference signals received via the antennas 822a-d. The downlink channel estimate (h_{DL,0}) may be determined based on a channel cluster structure, for example, as described herein with respect to FIG. 7. The UE may determine the uplink channel estimate associated with the first antenna 822a based on the following expression:

$${h}_{UL , 0} = {TXRX}_{mismatch} * {h}_{DL , 0} \qquad ( 1 )$$

where TXRX_{mismatch} may be a first adjustment factor used to convert the downlink channel estimate for the first antenna (h_{DL,0}) to the uplink channel estimate for the first antenna (h_{UL,0}). Expression (1) may be used to determine the uplink channel estimate of a particular antenna based on the downlink channel estimate associated with that antenna. The UE 804 may use the uplink channel estimate to precode uplink signaling, for example, for transmission of an SRS via the first antenna 822a.

In certain cases, the UE may determine the downlink channel estimate(s) for a subset of the antennas, such as the fourth antenna 822d. The UE may determine the uplink channel estimate associated with other antenna(s) (such as the first antenna 822a) based on the following expression:

$${h}_{UL , 0} = {TXRX}_{mismatch} * {Location}_{adjustment} * {h}_{DL , 3} \qquad ( 2 )$$

where Location_{adjustment} may be a second adjustment factor to account for the differences in locations between the receive antenna (e.g., the fourth antenna 822d) and the transmit antenna (e.g., the first antenna 822a). As an example, the fourth antenna 822d and the first antenna 822a may be separated by a first distance 832 (Δx) and a second distance 834 (Δy) along an x-axis and y-axis, respectively. The difference in signal propagation path lengths between the first antenna 822a and the fourth antenna 822d (e.g., first path length 836-second path length 838) may be given by the following expression:

$$Δ x cos θ + Δ y sin θ \qquad ( 3 )$$

where θ (840) may be the angle encountered at the cluster 806 for a signal transmission at the UE 804 via the first antenna 822a (e.g., the AoA or ZoA at the cluster).

The UE and/or the network entity may know (a priori) the distances Δx and Δy associated with the first antenna 822a and the fourth antenna 822d. For example, the UE may be configured with the distances Δx and Δy, and the UE may notify the network entity of the distances Δx and Δy via certain UE assistance information and/or capability information. The UE and/or the network entity may perform various techniques to determine the AoA (θ) for transmissions via the first antenna, for example, based on device positioning (such as deriving AoA based on the position of the UE and the cluster), perception information (such as video or camera images), sensor information, or the like. Note that the techniques for determination of the uplink channel estimate for the first antenna 822a based on the downlink channel estimate for the fourth antenna 822d may be applied to other downlink-uplink antenna combinations, such as between the first antenna 822a and the second antenna 822b among others.

In certain cases, the UE may have the antenna-transceiver architecture as described herein with respect to FIG. 6B. The beamformed channel on the downlink may have a different beam shape (e.g., a smaller beamwidth) than the beamformed channel on the uplink, for example, due to there being more antenna elements in the antenna array for reception than transmission. The UE may determine the downlink channel estimate(s) for an antenna array (such as the antenna array 622e of FIG. 6B), for example, based on measurement(s) of reference signals received via the antenna array. The UE may determine the uplink channel estimate associated with the antenna array based on the following expression:

$${h}_{UL} = {TXRX}_{mismatch} * {Beamwidth}_{adjustment} * {h}_{DL} \qquad ( 4 )$$

where Beamwidth_{adjustment} is a third adjustment factor used to account for the differences in beam shape between the transmit and receive beams used for FDD communications. Due to the difference in beam shape, the uplink and downlink channels may capture (or be formed from) different rays and/or clusters. Therefore, the gains (e.g., amplitudes) for received signals may be different for the uplink and downlink channels.

Note that the examples described herein with respect to Expressions (1)-(4) are provided to facilitate an understanding of uplink channel estimation based on a downlink channel estimate. Aspects of the present disclosure may be applied to determining a downlink channel estimate based on an uplink channel estimate. In certain cases, the network entity may determine the uplink and downlink channel estimate based on feedback from the UE.

### Example Signaling Related to Channel Estimation for FDD Communications

FIG. 9 depicts a process flow 900 for signaling related to channel estimation for FDD communications in a system between a network entity 902 and a user equipment (UE) 904. In some aspects, the network entity 902 may be an example of the BS 102 depicted and described with respect to FIG. 1, the first network entity 300 or the second network entity 302 depicted and described with respect to FIG. 3, or a disaggregated base station depicted and described with respect to FIG. 2. Similarly, the UE 904 may be an example of UE 104 depicted and described with respect to FIG. 1 or the UE 304 depicted and described with respect to FIG. 3. However, in other aspects, UE 904 may be another type of wireless communications device and network entity 902 may be another type of network entity or network node, such as those described herein. Note that any operations or signaling illustrated with dashed lines may indicate that that operation or signaling is an optional or alternative example.

At 906, the UE 904 obtains, from the network entity 902, one or more reference signals. The reference signal(s) may be or include, for example, one or more SSBs, one or more CSI-RSs, one or more DMRSs, and/or the like. In certain cases, the UE 904 may obtain the reference signal(s) using each of its antennas or a subset thereof.

At 908, the UE 904 determines, for each cluster of a set of clusters, cluster information. The set of clusters may be associated with a channel estimate for FDD communications between the UE 904 and the network entity 902, for example, as described herein with respect to FIG. 7. The channel estimate for FDD communications may be formed based on the set of clusters and/or the corresponding cluster information. The cluster information may include certain reciprocal information shared (or assumed to be shared) between a downlink channel and an uplink channel, such as angular information and/or delay information.

At 910, the UE 904 sends, to the network entity 902 an indication of the cluster information (for each cluster of the set of clusters) and the total number of clusters detected at the UE 904. The cluster information may be communicated via RRC signaling, MAC signaling, UCI, and/or the like.

At 912, the UE 904 optionally sends, to the network entity 902, one or more SRSs. In certain cases, the SRS transmission(s) may be channel precoded based on a downlink channel estimate, for example, as further described herein with respect to FIG. 10. In certain cases, the UE 904 may perform antenna switching to transmit the SRS(s). For example, the UE 904 may send the SRS(s) via a first set of antennas at a first transmission occasion, and then, the UE 904 may send the SRS(s) via a second set of antennas at a second transmission occasion. In certain cases, the UE 904 may send the SRS(s) using all of its antennas or a subset thereof. For example, when all of its antennas can transmit and receive signaling, the UE 904 may transmit the SRS(s) via one of the antennas, and the UE 904 may estimate or adjust the cluster information on all of the antennas.

At 914, the network entity 902 determines downlink and uplink channel estimates based on the cluster information and/or the received SRS(s). In certain cases, the network entity 902 may apply Expression(s) (1)-(4) to determine the downlink and uplink channel estimates. As an example, the network entity 902 may determine the uplink channel estimate based on the received SRS(s), and then the network entity 902 may convert the uplink channel estimate to a downlink channel estimate using Expression (1). In certain aspects, the cluster information may enable the network entity 902 to determine the downlink channel estimate and/or uplink channel estimate. For example, the cluster information may enable the network entity 902 to determine the adjustment factor(s) used to convert a downlink channel estimate into an uplink channel estimate, or vice versa.

In certain aspects, communication of the cluster information may enable reduced latencies, improved channel usage, and/or the like. Such technical effects and/or advantages may be due to the UE 904 providing channel state feedback (e.g., cluster information) that can be used to derive uplink and downlink channel estimate based on downlink signaling in the downlink.

At 916, the UE 904 communicates with the network entity 902 through FDD communications, for example, as described herein with respect to FIG. 5. As an example, the UE 904 may send, to the network entity 902, first signaling via a first set of frequency resources (e.g., corresponding to the uplink channel 502 of FIG. 5) during a first transmission occasion, and the UE 904 may obtain second signaling via a second set of frequency resources (e.g., corresponding the first downlink channel 504 and/or the second downlink channel 506 of FIG. 5) during the first transmission occasion. The first set of frequency resources may not overlap in the frequency domain with the second set of frequency resources.

The network entity 902 may configure the FDD communications with the UE 904 based on the downlink and uplink channel estimates, for example, in terms of transmit power, modulation and coding scheme (MCS), number of MIMO layers, or the like. In certain cases, the network entity 902 may perform downlink channel precoding based on the downlink channel estimate. In certain cases, the network entity 902 may configure uplink communications with the UE 904 based on the uplink channel estimate, such as configuring the transmit power, MCS, number of MIMO layers, or the like. The network entity 902 may notify the UE 904 of the configuration for uplink communications via an uplink grant, for example.

In certain cases, the network entity 902 and/or the UE 904 may use a digital twin framework (or digital twin assistance) to determine the cluster information for the set of clusters based on the received SRS(s) and/or the received reference signal(s). The digital twin framework may be or include a digital twin model that determines cluster information based on the received signaling. For example, the digital twin model may be or include a model of a transceiver used at the network entity 902 and/or the UE 904.

In certain cases, the digital twin model may be or include a digital representation (e.g., a virtual model) of a transceiver (including the antenna architecture) used at the network entity 902 and/or the UE 904 that simulates one or more operations of the transceiver. The simulated operations may include, for example, scrambling, modulation, layer mapping, precoding, resource mapping, RF signal generation and transmission, RF signal reception, resource demapping, post-coding, layer demapping, demodulation, descrambling, or the like. In certain cases, the digital twin framework may be or include another network entity that hosts a digital twin model configured to determine the cluster information. As an example, the network entity 902 may provide the received SRS(s) (or measurements thereof) to the digital twin model, and the digital twin model may provide the cluster information for the clusters of the downlink channel and/or uplink channel.

In certain cases, the channel estimation for FDD communications may be enabled via the SRS transmission(s) at 912 without communication of downlink reference signal(s) and cluster information at 906 and 910, respectively. For example, the network entity 902 may determine the number of clusters and corresponding cluster information based on the received SRS(s). The network entity 902 may determine the uplink channel estimate based on the clusters, and then, the network entity 902 may determine the downlink channel estimate based on the uplink channel estimate, for example, according to Expression (1).

FIG. 10 depicts another process flow 1000 for signaling related to channel estimation for FDD communications in a system between a network entity 1002 and a user equipment (UE) 1004. In some aspects, the network entity 1002 may be an example of the BS 102 depicted and described with respect to FIG. 1, the first network entity 300 or the second network entity 302 depicted and described with respect to FIG. 3, or a disaggregated base station depicted and described with respect to FIG. 2. Similarly, the UE 1004 may be an example of UE 104 depicted and described with respect to FIG. 1 or the UE 304 depicted and described with respect to FIG. 3. However, in other aspects, UE 1004 may be another type of wireless communications device and network entity 1002 may be another type of network entity or network node, such as those described herein. Note that any operations or signaling illustrated with dashed lines may indicate that that operation or signaling is an optional or alternative example.

At 1006, the UE 1004 obtains, from the network entity 1002, one or more reference signals, for example, as described herein with respect to FIG. 9.

At 1008, the UE 1004 determines a downlink channel estimate based on one more measurements of the received reference signal(s). In certain cases, the downlink channel estimate may be a cluster-based channel estimate. For example, the UE 1004 may determine, for each cluster of a set of clusters, cluster information associated with the downlink channel. The set of clusters may be associated with a channel estimate for FDD communications between the UE 1004 and the network entity 1002, for example, as described herein with respect to FIG. 7.

At 1010, the UE 1004 sends, to the network entity 1002, a first set of SRSs using a first channel precoding based at least in part on one or more measurements of the one or more RSs. The first channel precoding may be based at least in part on the downlink channel estimate determined at 1008. The first channel precoding may modulate the amplitude and phase shifts applied to the first set of SRSs based at least in part on the downlink channel estimate determined at 1008. For example, the first channel precoding may take into account the clusters associated with the downlink channel estimate and corresponding cluster properties, such as angular information, delay information, and/or gain information. The first channel precoding may be configured to form (e.g., beamform and/or modulate) the first set of SRSs for transmission via the clusters of the downlink channel estimate. The UE 1004 may send a respective first SRS, for each of the first set of SRSs, per transmit-receive beam pair of a plurality of transmit-receive beam pairs between the UE 1004 and the network entity 1002, such as the transmit-receive beam pair depicted in FIG. 7.

At 1012, the UE 1004 sends, to the network entity 1002, a second set of SRSs using a second channel precoding different from the first channel precoding. The second channel precoding may refrain from using the downlink channel estimate. The second channel precoding may be formed without the downlink channel estimate. For example, the second set of SRSs may be formed via the second channel precoding such that a comparison between the first set of SRSs and the second set of SRSs may indicate the downlink channel estimate used to form the first set of SRSs. In certain cases, the UE 1004 may send a respective second SRS, for each of the second set of SRSs, per transmit antenna of a plurality of transmit antennas of the UE 1004.

In certain aspects, communication of the first set of SRSs and the second set of SRSs may enable improved channel usage for channel estimation. For example, the improved channel usage may be attributable to the first set of SRSs and the second set of SRSs occupying less signaling overhead compared to explicit feedback of the cluster information.

At 1014, the network entity 1002 determines downlink and uplink channel estimates based on the received SRS(s), for example, as described herein with respect to FIG. 9. For example, the network entity 1002 may determine the uplink channel estimate based on the received second set of SRSs. The network entity 1002 may determine the downlink channel estimate based on a comparison between the first set of SRSs and the second set of SRSs.

At 1016, the UE 1004 communicates with the network entity 1002 through FDD communications, for example, as described herein with respect to FIG. 9.

Note that the process flows illustrated in FIGS. 9 and 10 are described herein to facilitate an understanding of channel estimation for FDD communications, and aspects of the present disclosure may be performed in various manners via alternative or additional signaling and/or operations. In certain aspects, the operations and/or signaling of FIGS. 9 and 10 may occur in an order different from that described or depicted, and various actions, operations, and/or signaling may be added, omitted, or combined.

### Example Operations of Channel Estimation for FDD Communications

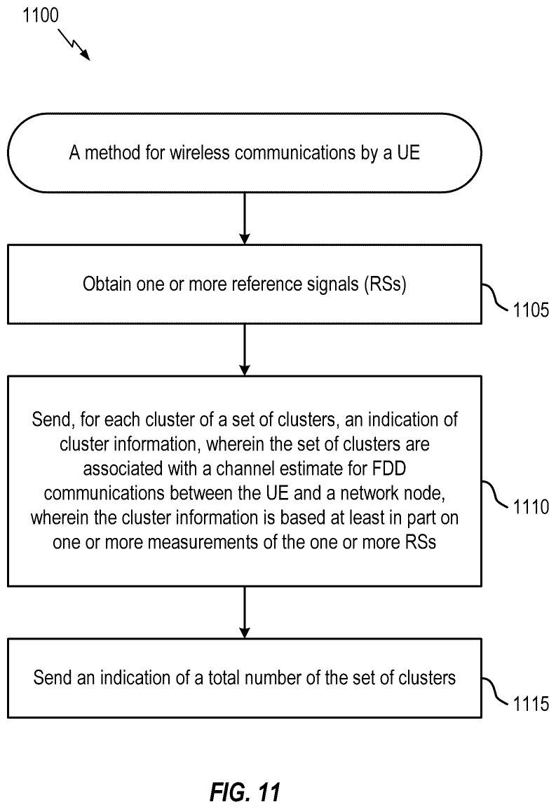

FIG. 11 shows a method 1100 for wireless communications by an apparatus, such as UE 104 of FIG. 1 or UE 304 of FIG. 3.

Method 1100 begins at block 1105 with obtaining one or more RSs, for example, as described herein with respect to FIGS. 7-10.

Method 1100 then proceeds to block 1110 with sending, for each cluster of a set of clusters, an indication of cluster information, wherein the set of clusters is associated with a channel estimate for FDD communications between the UE and a network node, wherein the cluster information is based at least in part on one or more measurements of the one or more RSs, for example, as described herein with respect to FIGS. 7-10.

Method 1100 then proceeds to block 1115 with sending an indication of a total number of the set of clusters, for example, as described herein with respect to FIGS. 7-10.

In certain aspects, method 1100 further includes determining, for each cluster of the set of clusters, the cluster information based at least in part on one or more measurements of the one or more RSs.

In certain aspects, the cluster information comprises one or more of: an angle of arrival in one or more of azimuth or zenith; an angle of departure in one or more of azimuth or zenith; an angular spread in one or more of azimuth or zenith; a root-mean squared delay spread; or gain information.

In certain aspects, each cluster of the set of clusters comprises a set of multipath components for at least a portion of a propagation path between the UE and the network node.

In certain aspects, method 1100 further includes obtaining an indication to send one or more SRSs for downlink channel estimation of FDD communications. In certain aspects, method 1100 further includes sending at least one SRS.

In certain aspects, sending the at least one SRS comprises sending a first set of SRSs using a first channel precoding based at least in part on one or more measurements of the one or more RSs; and sending a second set of SRSs using a second channel precoding different from the first channel precoding, for example, as described herein with respect to FIGS. 7 and 10.

In certain aspects, the first channel precoding is based at least in part on a downlink channel estimate.

In certain aspects, sending the first set of SRSs comprises sending a respective first SRS, for each of the first set of SRSs, per transmit-receive beam pair of a plurality of transmit-receive beam pairs; and sending the second set of SRSs comprises sending a respective second SRS, for each of the second set of SRSs, per transmit antenna of a plurality of transmit antennas.

In certain aspects, block 1105 includes: obtaining the one or more RSs via a plurality of antennas including a first set of antennas and a second set of antennas; and sending the at least one SRS comprises sending a first set of SRSs, based at least in part on one or more measurements of the one or more RSs, via the first set of antennas in one or more first transmission occasions; and sending a second set of SRSs, based at least in part on one or more measurements of the one or more RSs, via the second set of antennas in one or more second transmission occasions.

In certain aspects, block 1105 includes: obtaining the one or more RSs via a plurality of antennas including a first set of antennas and a second set of antennas; and sending the at least one SRS comprises sending the at least one SRS, based at least in part on one or more measurements of the one or more RSs, via the first set of antennas.

In certain aspects, block 1105 includes obtaining the one or more RSs via a plurality of antennas; sending the at least one SRS comprises sending the at least one SRS, based at least in part on one or more measurements of the one or more RSs; and the method 1100 further comprises obtaining signaling, based at least in part on the one or more measurements of the one or more RSs, via at least one of the plurality of antennas.

In certain aspects, method 1100 further includes determining a downlink channel estimate of FDD communications based at least in part on one or more measurements of the one or more RSs. In certain aspects, method 1100 further includes determining an uplink channel estimate of the FDD communications based at least in part on a relationship between the downlink channel estimate and the uplink channel estimate. In certain aspects, method 1100 further includes sending signaling using channel precoding based at least in part on the uplink channel estimate. In certain aspects, the relationship comprises a beamwidth adjustment associated with a receive beam and a transmit beam. In certain aspects, the relationship comprises a location adjustment associated with a first antenna and a second antenna.

In certain aspects, method 1100 further includes communicating FDD communications based at least in part on the cluster information. In certain aspects, communicating the FDD communications comprises obtaining signaling precoded based at least in part on the cluster information. In certain aspects, communicating the FDD communications comprises: sending first signaling via a first set of frequency resources during a first transmission occasion; and obtaining second signaling via a second set of frequency resources during the first transmission occasion, wherein the first set of frequency resources do not overlap in a frequency domain with the second set of frequency resources.

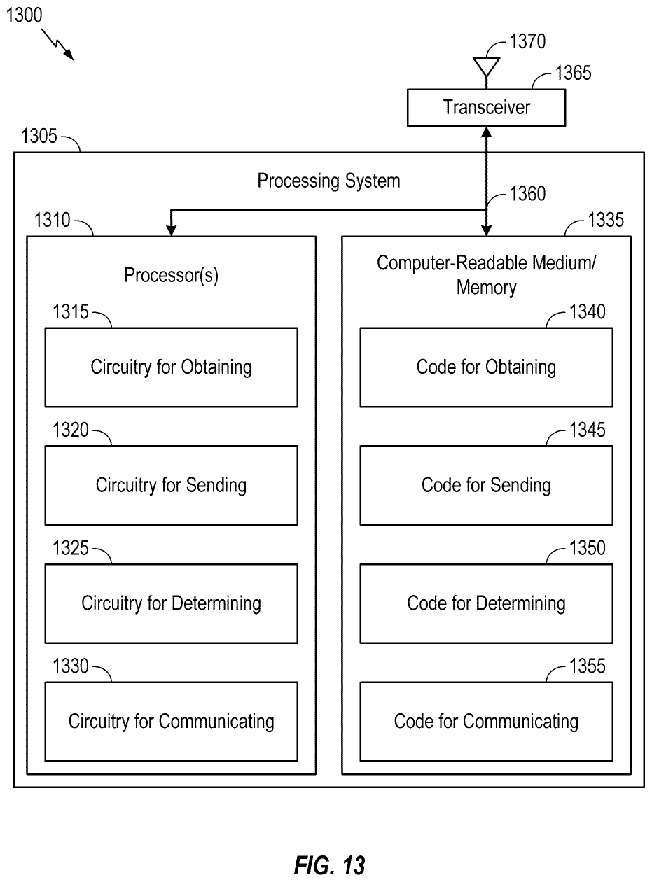

In certain aspects, method 1100, or any aspect related to it, may be performed by an apparatus, such as communications device 1300 of FIG. 13, which includes various components operable, configured, or adapted to perform the method 1100. Communications device 1300 is described below in further detail.

Note that FIG. 11 is just one example of a method, and other methods including fewer, additional, or alternative operations are possible consistent with this disclosure.

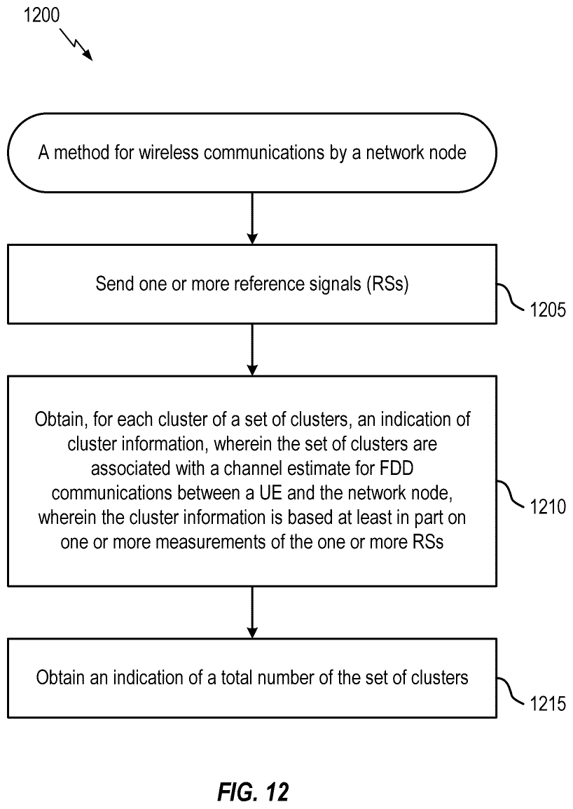

FIG. 12 shows a method 1200 for wireless communications by a network node, such as BS 102 of FIG. 1, a first network entity 300 or second network entity 302 of FIG. 3, or a disaggregated base station as discussed with respect to FIG. 2.

Method 1200 begins at block 1205 with sending one or more RSs, for example, as described herein with respect to FIGS. 7-10.

Method 1200 then proceeds to block 1210 with obtaining, for each cluster of a set of clusters, an indication of cluster information, wherein the set of clusters is associated with a channel estimate for FDD communications between a UE and the network node, wherein the cluster information is based at least in part on one or more measurements of the one or more RSs, for example, as described herein with respect to FIGS. 7-10.

Method 1200 then proceeds to block 1215 with obtaining an indication of a total number of the set of clusters, for example, as described herein with respect to FIGS. 7-10.

In certain aspects, the cluster information comprises one or more of: an angle of arrival in one or more of azimuth or zenith; an angle of departure in one or more of azimuth or zenith; an angular spread in one or more of azimuth or zenith; a root-mean squared delay spread; or gain information.

In certain aspects, each cluster of the set of clusters comprises a set of multipath components for at least a portion of a propagation path between the UE and the network node.

In certain aspects, method 1200 further includes sending an indication to send one or more SRSs for downlink channel estimation of FDD communications. In certain aspects, method 1200 further includes obtaining at least one SRS.

In certain aspects, obtaining the at least one SRS comprises: obtaining a first set of SRSs precoded via a first channel precoding; and obtaining a second set of SRSs precoded via a second channel precoding different from the first channel precoding. In certain aspects, the first channel precoding is based at least in part on a downlink channel estimate.

In certain aspects, obtaining the first set of SRSs comprises: obtaining a respective first SRS, for each of the first set of SRSs, per transmit-receive beam pair of a plurality of transmit-receive beam pairs; and obtaining the second set of SRSs comprises obtaining a respective second SRS, for each of the second set of SRSs, per transmit antenna of a plurality of transmit antennas.

In certain aspects, obtaining the at least one SRS comprises: obtaining a first set of SRSs in one or more first transmission occasions; and obtaining a second set of SRSs in one or more second transmission occasions.

In certain aspects, method 1200 further includes determining an uplink channel estimate of FDD communications based at least in part on one or more measurements of the one or more SRSs. In certain aspects, method 1200 further includes determining a downlink channel estimate of the FDD communications based at least in part on a relationship between the downlink channel estimate and the uplink channel estimate. In certain aspects, method 1200 further includes sending signaling using channel precoding based at least in part on the downlink channel estimate. In certain aspects, the relationship comprises a beamwidth adjustment associated with a receive beam and a transmit beam. In certain aspects, the relationship comprises a location adjustment associated with a first antenna and a second antenna.

In certain aspects, method 1200 further includes communicating FDD communications based at least in part on the cluster information. In certain aspects, communicating the FDD communications comprises sending signaling precoded based at least in part on the cluster information.

In certain aspects, communicating the FDD communications comprises: sending first signaling via a first set of frequency resources during a first transmission occasion; and obtaining second signaling via a second set of frequency resources during the first transmission occasion, wherein the first set of frequency resources do not overlap in a frequency domain with the second set of frequency resources.

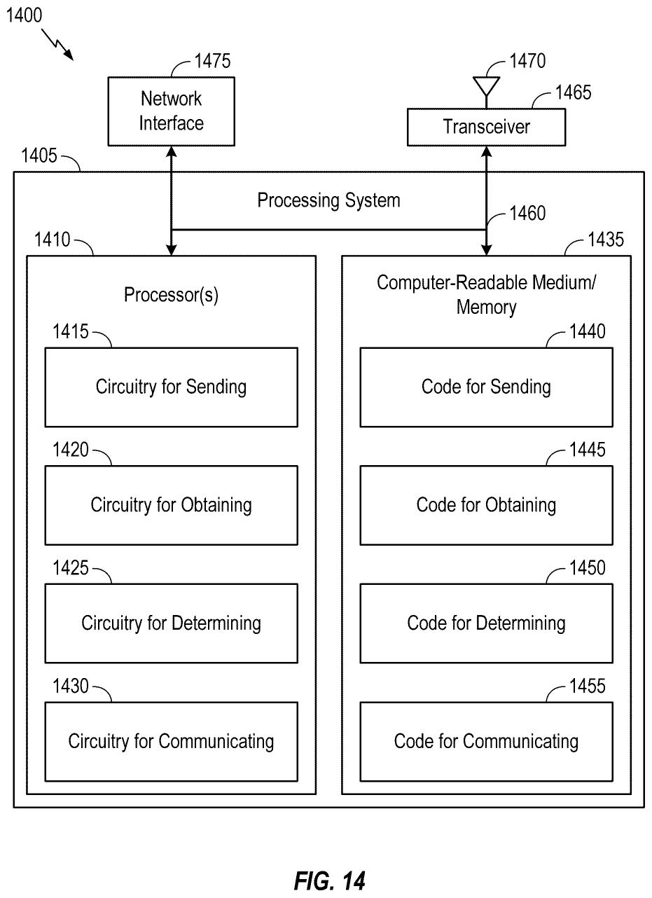

In certain aspects, method 1200, or any aspect related to it, may be performed by an apparatus, such as communications device 1400 of FIG. 14, which includes various components operable, configured, or adapted to perform the method 1200. Communications device 1400 is described below in further detail.

Note that FIG. 12 is just one example of a method, and other methods including fewer, additional, or alternative operations are possible consistent with this disclosure.

### Example Communications Devices

FIG. 13 depicts aspects of an example communications device 1300 configured for wireless communications. In some aspects, communications device 1300 is a user equipment, such as UE 104 described above with respect to FIG. 1 or UE 304 described with respect to FIG. 3.

The communications device 1300 includes a processing system 1305 coupled to a transceiver 1365 (e.g., a transmitter and/or a receiver). The transceiver 1365 is configured to transmit and receive signals for the communications device 1300 via an antenna 1370, such as the various signals as described herein. The processing system 1305 may be configured to perform processing functions for the communications device 1300, including processing signals received and/or to be transmitted by the communications device 1300.

The processing system 1305 includes one or more processors 1310 and a computer-readable medium/memory 1335. In various aspects, the one or more processors 1310 may be representative of the one or more processors 318 described with respect to FIG. 3. The one or more processors 1310 are coupled to a computer-readable medium/memory 1335 via a bus 1360. In some aspects, the computer-readable medium/memory 1335 may be representative of the one or more memories 320 described with respect to FIG. 3. The computer-readable medium/memory 1335 is a non-transitory computer-readable medium/memory. In certain aspects, the computer-readable medium/memory 1335 is configured to store instructions (e.g., computer-executable code), that when executed by the one or more processors 1310, cause the one or more processors 1310 to perform the method 1100 described with respect to FIG. 11, or any aspect related to it, including any operations described in relation to FIG. 11. Note that reference to a processor performing a function of communications device 1300 may include one or more processors performing that function of communications device 1300, such as in a distributed fashion.

In the depicted example, computer-readable medium/memory 1335 stores code (e.g., executable instructions), including code for obtaining 1340, code for sending 1345, code for determining 1350, and code for communicating 1355. Processing of the code 1340-1355 may enable and cause the communications device 1300 to perform the method 1100 described with respect to FIG. 11, or any aspect related to it.

The one or more processors 1310 include circuitry configured to implement (e.g., execute) the code stored in the computer-readable medium/memory 1335, including circuitry for obtaining 1315, circuitry for sending 1320, circuitry for determining 1325, and circuitry for communicating 1330. Processing with circuitry 1315-1330 may enable and cause the communications device 1300 to perform the method 1100 described with respect to FIG. 11, or any aspect related to it.

More generally, means for communicating, transmitting, sending or outputting for transmission may include the one or more transceivers 324, one or more antenna 322 and/or processing system 316 of the UE 304 illustrated in FIG. 3, transceiver 1365 and/or antenna 1370 of the communications device 1300 in FIG. 13, and/or one or more processors 1310 of the communications device 1300 in FIG. 13. Means for communicating, receiving or obtaining may include the one or more transceivers 324, one or more antennas 322, and/or processing system 316 of the UE 304 illustrated in FIG. 3, transceiver 1365 and/or antenna 1370 of the communications device 1300 in FIG. 13, and/or one or more processors 1310 of the communications device 1300 in FIG. 13. For example, means for determining of the method 1100 described with respect to FIG. 11, or any aspect related to it, may include the processing system 316 of the UE 304 and/or the one or more processors 1310 of the communications device 1300 in FIG. 13.

FIG. 14 depicts aspects of an example communications device configured for wireless communications. In some aspects, communications device 1400 is a network entity, such as BS 102 of FIG. 1, first network entity 300 or second network entity 302 of FIG. 3, or a disaggregated base station as discussed with respect to FIG. 2.

The communications device 1400 includes a processing system 1405 coupled to a transceiver 1465 (e.g., a transmitter and/or a receiver) and/or a network interface 1475. The transceiver 1465 is configured to transmit and receive signals for the communications device 1400 via an antenna 1470, such as the various signals as described herein. The network interface 1475 is configured to obtain and send signals for the communications device 1400 via communications link(s), such as a backhaul link, midhaul link, and/or fronthaul link as described herein, such as with respect to FIG. 2. The processing system 1405 may be configured to perform processing functions for the communications device 1400, including processing signals received and/or to be transmitted by the communications device 1400.

The processing system 1405 includes one or more processors 1410 and a computer-readable medium/memory 1435. In various aspects, one or more processors 1410 may be representative of the one or more processors 308, as described with respect to FIG. 3. The one or more processors 1410 are coupled to the computer-readable medium/memory 1435 via a bus 1460. In certain aspects, the computer-readable medium/memory 1435 is configured to store instructions (e.g., computer-executable code), including code 1440-1455, that when executed by the one or more processors 1410, cause the one or more processors 1410 to perform the method 1200 described with respect to FIG. 12, or any aspect related to it, including any operations described in relation to FIG. 12. The computer-readable medium/memory 1410 is a non-transitory computer-readable medium/memory. Note that reference to a processor of communications device 1400 performing a function may include one or more processors of communications device 1400 performing that function, such as in a distributed fashion.

In the depicted example, the computer-readable medium/memory 1435 stores code (e.g., executable instructions), including code for sending 1440, code for obtaining 1445, code for determining 1450, and code for communicating 1455. Processing of the code 1440-1455 may enable and cause the communications device 1400 to perform the method 1200 described with respect to FIG. 12, or any aspect related to it.

The one or more processors 1410 include circuitry configured to implement (e.g., execute) the code stored in the computer-readable medium/memory 1435, including circuitry for sending 1415, circuitry for obtaining 1420, circuitry for determining 1425, and circuitry for communicating 1430. Processing with circuitry 1415-1430 may enable and cause the communications device 1400 to perform the method 1200 described with respect to FIG. 12, or any aspect related to it.

Various components of the communications device 1400 may provide means for performing the method 1200 described with respect to FIG. 12, or any aspect related to it. Means for communicating, transmitting, sending or outputting for transmission may include the one or more transceivers 312, one or more antennas 314, and/or processing system 306 of the first network entity 300 or the second network entity 302 illustrated in FIG. 3, transceiver 1465, antenna 1470, and/or network interface 1475 of the communications device 1400 in FIG. 14, and/or one or more processors 1410 of the communications device 1400 in FIG. 14. Means for communicating, receiving or obtaining may include the one or more transceivers 312, one or more antennas 314, and/or processing system 306 of the first network entity 300 or the second network entity 302 illustrated in FIG. 3, transceiver 1465, antenna 1470, and/or network interface 1475 of the communications device 1400 in FIG. 14, and/or one or more processors 1410 of the communications device 1400 in FIG. 14. For example, means for determining of the method 1200 described with respect to FIG. 12, or any aspect related to it, may include processing system 306 of the first network entity 300 or the second network entity 302 illustrated in FIG. 3, and/or the one or more processors 1410 of the communications device 1400 in FIG. 14.

### Example Clauses

Implementation examples are described in the following numbered clauses:
Clause 1: A method for wireless communications by a UE, comprising: obtaining one or more RSs; sending, for each cluster of a set of clusters, an indication of cluster information, wherein the set of clusters is associated with a channel estimate for FDD communications between the UE and a network node, wherein the cluster information is based at least in part on one or more measurements of the one or more RSs; and sending an indication of a total number of the set of clusters.
Clause 2: The method of Clause 1, further comprising determining, for each cluster of the set of clusters, the cluster information based at least in part on one or more measurements of the one or more RSs.
Clause 3: The method of any one of Clauses 1-2, wherein the cluster information comprises one or more of: an angle of arrival in one or more of azimuth or zenith; an angle of departure in one or more of azimuth or zenith; an angular spread in one or more of azimuth or zenith; a root-mean squared delay spread; or gain information.
Clause 4: The method of any one of Clauses 1-3, wherein each cluster of the set of clusters comprises a set of multipath components for at least a portion of a propagation path between the UE and the network node.
Clause 5: The method of any one of Clauses 1-4, further comprising: obtaining an indication to send one or more SRSs for downlink channel estimation of FDD communications; and sending at least one SRS.
Clause 6: The method of Clause 5, wherein sending the at least one SRS comprises: sending a first set of SRSs using a first channel precoding based at least in part on one or more measurements of the one or more RSs; and sending a second set of SRSs using a second channel precoding different from the first channel precoding.
Clause 7: The method of Clause 6, wherein the first channel precoding is based at least in part on a downlink channel estimate.
Clause 8: The method of Clause 6, wherein: sending the first set of SRSs comprises sending a respective first SRS, for each of the first set of SRSs, per transmit-receive beam pair of a plurality of transmit-receive beam pairs; and sending the second set of SRSs comprises sending a respective second SRS, for each of the second set of SRSs, per transmit antenna of a plurality of transmit antennas.
Clause 9: The method of Clause 5, wherein: obtaining the one or more RSs comprises obtaining the one or more RSs via a plurality of antennas including a first set of antennas and a second set of antennas; and sending the at least one SRS comprises: sending a first set of SRSs, based at least in part on one or more measurements of the one or more RSs, via the first set of antennas in one or more first transmission occasions; and sending a second set of SRSs, based at least in part on one or more measurements of the one or more RSs, via the second set of antennas in one or more second transmission occasions.
Clause 10: The method of Clause 5, wherein: obtaining the one or more RSs comprises obtaining the one or more RSs via a plurality of antennas including a first set of antennas and a second set of antennas; and sending the at least one SRS comprises sending the at least one SRS, based at least in part on one or more measurements of the one or more RSs, via the first set of antennas.
Clause 11: The method of Clause 5, wherein: obtaining the one or more RSs comprises obtaining the one or more RSs via a plurality of antennas; sending the at least one SRS comprises sending the at least one SRS, based at least in part on one or more measurements of the one or more RSs; and the method further comprises obtaining signaling, based at least in part on the one or more measurements of the one or more RSs, via at least one of the plurality of antennas.
Clause 12: The method of any one of Clauses 1-11, further comprising: determining a downlink channel estimate of FDD communications based at least in part on one or more measurements of the one or more RSs; determining an uplink channel estimate of the FDD communications based at least in part on a relationship between the downlink channel estimate and the uplink channel estimate; and sending signaling using channel precoding based at least in part on the uplink channel estimate.
Clause 13: The method of Clause 12, wherein the relationship comprises a beamwidth adjustment associated with a receive beam and a transmit beam.
Clause 14: The method of Clause 12, wherein the relationship comprises a location adjustment associated with a first antenna and a second antenna.
Clause 15: The method of any one of Clauses 1-14, further comprising communicating FDD communications based at least in part on the cluster information.
Clause 16: The method of Clause 15, wherein communicating the FDD communications comprises obtaining signaling precoded based at least in part on the cluster information.
Clause 17: The method of Clause 15, wherein communicating the FDD communications comprises sending first signaling via a first set of frequency resources during a first transmission occasion; and obtaining second signaling via a second set of frequency resources during the first transmission occasion, wherein the first set of frequency resources do not overlap in a frequency domain with the second set of frequency resources.
Clause 18: A method for wireless communications by a network node, comprising: sending one or more RSs; obtaining, for each cluster of a set of clusters, an indication of cluster information, wherein the set of clusters is associated with a channel estimate for FDD communications between a UE and the network node, wherein the cluster information is based at least in part on one or more measurements of the one or more RSs; and obtaining an indication of a total number of the set of clusters.
Clause 19: The method of Clause 18, wherein the cluster information comprises one or more of: an angle of arrival in one or more of azimuth or zenith; an angle of departure in one or more of azimuth or zenith; an angular spread in one or more of azimuth or zenith; a root-mean squared delay spread; or gain information.
Clause 20: The method of any one of Clauses 18-19, wherein each cluster of the set of clusters comprises a set of multipath components for at least a portion of a propagation path between the UE and the network node.
Clause 21: The method of any one of Clauses 18-20, further comprising: sending an indication to send one or more SRSs for downlink channel estimation of FDD communications; and obtaining at least one SRS.
Clause 22: The method of Clause 21, wherein obtaining the at least one SRS comprises: obtaining a first set of SRSs precoded via a first channel precoding; and obtaining a second set of SRSs precoded via a second channel precoding different from the first channel precoding.
Clause 23: The method of Clause 22, wherein the first channel precoding is based at least in part on a downlink channel estimate.
Clause 24: The method of Clause 22, wherein: obtaining the first set of SRSs comprises obtaining a respective first SRS, for each of the first set of SRSs, per transmit-receive beam pair of a plurality of transmit-receive beam pairs; and obtaining the second set of SRSs comprises obtaining a respective second SRS, for each of the second set of SRSs, per transmit antenna of a plurality of transmit antennas.
Clause 25: The method of Clause 21, wherein obtaining the at least one SRS comprises: obtaining a first set of SRSs in one or more first transmission occasions; and obtaining a second set of SRSs in one or more second transmission occasions.
Clause 26: The method of Clause 21, further comprising: determining an uplink channel estimate of FDD communications based at least in part on one or more measurements of the one or more SRSs; determining a downlink channel estimate of the FDD communications based at least in part on a relationship between the downlink channel estimate and the uplink channel estimate; and sending signaling using channel precoding based at least in part on the downlink channel estimate.
Clause 27: The method of Clause 26, wherein the relationship comprises a beamwidth adjustment associated with a receive beam and a transmit beam.
Clause 28: The method of Clause 26, wherein the relationship comprises a location adjustment associated with a first antenna and a second antenna.
Clause 29: The method of any one of Clauses 18-28, further comprising communicating FDD communications based at least in part on the cluster information.
Clause 30: The method of Clause 29, wherein communicating the FDD communications comprises sending signaling precoded based at least in part on the cluster information.
Clause 31: The method of Clause 29, wherein communicating the FDD communications comprises: sending first signaling via a first set of frequency resources during a first transmission occasion; and obtaining second signaling via a second set of frequency resources during the first transmission occasion, wherein the first set of frequency resources do not overlap in a frequency domain with the second set of frequency resources.
Clause 32: One or more apparatuses, comprising: one or more memories comprising executable instructions; and one or more processors configured to execute the executable instructions and cause the one or more apparatuses to perform a method in accordance with any one of Clauses 1-31.
Clause 33: One or more apparatuses configured for wireless communications, comprising: one or more memories; and one or more processors, coupled to the one or more memories, configured to cause the one or more apparatuses to perform a method in accordance with any one of Clauses 1-31.
Clause 34: One or more apparatuses configured for wireless communications, comprising: one or more memories; and one or more processors, coupled to the one or more memories, configured to perform a method in accordance with any one of Clauses 1-31.
Clause 35: One or more apparatuses, comprising means for performing a method in accordance with any one of Clauses 1-31.
Clause 36: One or more non-transitory computer-readable media comprising executable instructions that, when executed by one or more processors of one or more apparatuses, cause the one or more apparatuses to perform a method in accordance with any one of Clauses 1-31.
Clause 37: One or more computer program products embodied on one or more computer-readable storage media comprising code for performing a method in accordance with any one of Clauses 1-31.
Clause 38: One or more apparatuses configured for wireless communications, comprising: a processing system that includes one or more processors and one or more memories coupled with the one or more processors, the processing system configured to cause the one or more apparatuses to perform a method in accordance with any one of Clauses 1-31.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, an AI processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a SoC, a SiP, or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, “coupled to” and “coupled with” generally encompass direct coupling and indirect coupling (e.g., including intermediary coupled aspects) unless stated otherwise. For example, stating that a processor is coupled to a memory allows for a direct coupling or a coupling via an intermediary aspect, such as a bus.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an ASIC, or processor.

The following claims are not intended to be limited to the aspects shown herein, but are to be accorded the full scope consistent with the language of the claims. Reference to an element in the singular is not intended to mean only one unless specifically so stated, but rather “one or more.” The subsequent use of a definite article (e.g., “the” or “said”) with an element (e.g., “the processor”) is not intended to invoke a singular meaning (e.g., “only one”) on the element unless otherwise specifically stated. For example, reference to an element (e.g., “a processor,” “the processor,” etc.), unless otherwise specifically stated, should be understood to refer to one or more elements (e.g., “one or more processors,” or the like). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more. All structural and functional equivalents to the elements of the various aspects described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims.

What is claimed is:

1. An apparatus for wireless communications, comprising a processing system that includes one or more processors and one or more memories coupled with the one or more processors, the processing system configured to cause a user equipment (UE) to:
obtain one or more reference signals (RSs); and
send, for each cluster of a set of clusters, an indication of cluster information, wherein the set of clusters is associated with a channel estimate for frequency division duplex (FDD) communications between the UE and a network node, wherein the cluster information is based at least in part on one or more measurements of the one or more RSs; and
send an indication of a total number of the set of clusters.

2. The apparatus of claim 1, wherein the processing system is configured to cause the UE to determine, for each cluster of the set of clusters, the cluster information based at least in part on one or more measurements of the one or more RSs.

3. The apparatus of claim 1, wherein the cluster information comprises one or more of:
an angle of arrival in one or more of azimuth or zenith;
an angle of departure in one or more of azimuth or zenith;
an angular spread in one or more of azimuth or zenith;
a root-mean squared delay spread; or
gain information.

4. The apparatus of claim 1, wherein each cluster of the set of clusters comprises a set of multipath components for at least a portion of a propagation path between the UE and the network node.

5. The apparatus of claim 1, wherein the processing system is configured to cause the UE to:
obtain an indication to send one or more sounding reference signals (SRSs) for downlink channel estimation of FDD communications; and
send at least one SRS.

6. The apparatus of claim 5, wherein to send the at least one SRS, the processing system is configured to cause the UE to:
send a first set of SRSs using a first channel precoding based at least in part on one or more measurements of the one or more RSs; and
send a second set of SRSs using a second channel precoding different from the first channel precoding.

7. The apparatus of claim 6, wherein the first channel precoding is based at least in part on a downlink channel estimate.

8. The apparatus of claim 6, wherein:
to send the first set of SRSs, the processing system is configured to cause the UE to send a respective first SRS, for each of the first set of SRSs, per transmit-receive beam pair of a plurality of transmit-receive beam pairs; and
to send the second set of SRSs, the processing system is configured to cause the UE to send a respective second SRS, for each of the second set of SRSs, per transmit antenna of a plurality of transmit antennas.

9. The apparatus of claim 5, wherein:
to obtain the one or more RSs, the processing system is configured to cause the UE to obtain the one or more RSs via a plurality of antennas including a first set of antennas and a second set of antennas; and
to send the at least one SRS, the processing system is configured to cause the UE to:
send a first set of SRSs, based at least in part on one or more measurements of the one or more RSs, via the first set of antennas in one or more first transmission occasions; and
send a second set of SRSs, based at least in part on one or more measurements of the one or more RSs, via the second set of antennas in one or more second transmission occasions.

10. The apparatus of claim 5, wherein:
to obtain the one or more RSs, the processing system is configured to cause the UE to obtain the one or more RSs via a plurality of antennas including a first set of antennas and a second set of antennas; and
to send the at least one SRS, the processing system is configured to cause the UE to send the at least one SRS, based at least in part on one or more measurements of the one or more RSs, via the first set of antennas.

11. The apparatus of claim 5, wherein:
to obtain the one or more RSs, the processing system is configured to cause the UE to obtain the one or more RSs via a plurality of antennas;
to send the at least one SRS, the processing system is configured to cause the UE to send the at least one SRS, based at least in part on one or more measurements of the one or more RSs; and
the processing system is configured to cause the UE to obtain signaling, based at least in part on the one or more measurements of the one or more RSs, via at least one of the plurality of antennas.

12. The apparatus of claim 1, wherein the processing system is configured to cause the UE to:
determine a downlink channel estimate of FDD communications based at least in part on one or more measurements of the one or more RSs;
determine an uplink channel estimate of the FDD communications based at least in part on a relationship between the downlink channel estimate and the uplink channel estimate; and
send signaling using channel precoding based at least in part on the uplink channel estimate.

13. The apparatus of claim 12, wherein the relationship comprises a beamwidth adjustment associated with a receive beam and a transmit beam.

14. The apparatus of claim 12, wherein the relationship comprises a location adjustment associated with a first antenna and a second antenna.

15. The apparatus of claim 1, wherein the processing system is configured to cause the UE to communicate FDD communications based at least in part on the cluster information.

16. The apparatus of claim 15, wherein to communicate the FDD communications, the processing system is configured to cause the UE to obtain signaling precoded based at least in part on the cluster information.

17. The apparatus of claim 15, wherein to communicate the FDD communications, the processing system is configured to cause the UE to:
send first signaling via a first set of frequency resources during a first transmission occasion; and
obtain second signaling via a second set of frequency resources during the first transmission occasion, wherein the first set of frequency resources do not overlap in a frequency domain with the second set of frequency resources.

18. An apparatus for wireless communications, comprising a processing system that includes one or more processors and one or more memories coupled with the one or more processors, the processing system configured to cause a network node to:
send one or more reference signals (RSs); and
obtain, for each cluster of a set of clusters, an indication of cluster information, wherein the set of clusters is associated with a channel estimate for frequency division duplex (FDD) communications between a user equipment (UE) and the network node, wherein the cluster information is based at least in part on one or more measurements of the one or more RSs; and
obtain an indication of a total number of the set of clusters.

19. The apparatus of claim 18, wherein the cluster information comprises one or more of:
an angle of arrival in one or more of azimuth or zenith;
an angle of departure in one or more of azimuth or zenith;
an angular spread in one or more of azimuth or zenith;
a root-mean squared delay spread; or
gain information.

20. A method for wireless communications by a user equipment (UE), comprising:
obtaining one or more reference signals (RSS); and
sending, for each cluster of a set of clusters, an indication of cluster information, wherein the set of clusters is associated with a channel estimate for frequency division duplex (FDD) communications between the UE and a network node, wherein the cluster information is based at least in part on one or more measurements of the one or more RSs; and
sending an indication of a total number of the set of clusters.
